(19) United States
(12) Patent Application Publication
(10) Pub. No.: US 2026/0027480 A1
(43) Pub. Date: Jan. 29, 2026

(54) METHOD FOR SHOOTING IN VIRTUAL SCENE, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Kangyi WANG, Shenzhen (CN); Mingzi QIU, Shenzhen (CN)

(21) Appl. No.: 19/348,563

(22) Filed: Oct. 2, 2025

Related U.S. Application Data
(63) Continuation of application No. PCT/CN2024/121051, filed on Sep. 25, 2024.

(30) Foreign Application Priority Data
Dec. 14, 2023 (CN) 202311724892.5

(51) Int. Cl. A63F 13/837; A63F 13/57

(52) U.S. Cl. CPC A63F 13/837; A63F 13/57

(57) ABSTRACT

A method for shooting in a virtual scene includes displaying, in a virtual scene, a virtual vehicle and a virtual object located in the virtual vehicle; and controlling, in response to a shooting instruction, the virtual object to shoot toward outside of the virtual vehicle, during a process that the virtual object shoots toward outside of the virtual vehicle, an entirety of the virtual object being located inside the virtual vehicle.

### CROSS-REFERENCES TO RELATED APPLICATIONS

This application is a continuation application of PCT Patent Application No. PCT/CN2024/121051, filed on Sep. 25, 2024, which claims priority to Chinese Patent Application No. 202311724892.5, filed on Dec. 14, 2023, all of which is incorporated by reference in their entirety.

### FIELD OF THE TECHNOLOGY

The present disclosure relates to the technical field of Internet, and in particular, to a method and apparatus for shooting in a virtual scene, an electronic device, a computer-readable storage medium, and a computer program product.

### BACKGROUND OF THE DISCLOSURE

In games of related technologies, if a player wants to shoot toward outside of a virtual vehicle when controlling a virtual object riding in the virtual vehicle, the player needs to first control the virtual object to lean out of the virtual vehicle based on a control, and then control the virtual object that pops out of the virtual vehicle to shoot toward outside of the virtual vehicle. However, such a shooting manner is overly cumbersome, resulting in low execution efficiency of shooting operations in a virtual scene and low human-computer interaction efficiency.

### SUMMARY

One embodiment of the present disclosure provides a method for shooting in a virtual scene, performed by an electronic device. The method includes displaying, in a virtual scene, a virtual vehicle and a virtual object located in the virtual vehicle; and controlling, in response to a shooting instruction, the virtual object to shoot toward outside of the virtual vehicle, during a process that the virtual object shoots toward outside of the virtual vehicle, an entirety of the virtual object being located inside the virtual vehicle.

Another embodiment of the present disclosure provides an electronic device. The electronic device includes one or more processors and a memory containing computer-executable instructions or a computer program that, when being executed, cause the one or more processors to perform: displaying, in a virtual scene, a virtual vehicle and a virtual object located in the virtual vehicle; and controlling, in response to a shooting instruction, the virtual object to shoot toward outside of the virtual vehicle, during a process that the virtual object shoots toward outside of the virtual vehicle, an entirety of the virtual object being located inside the virtual vehicle.

Another embodiment of the present disclosure provides a non-transitory computer-readable storage medium containing computer-executable instructions or a computer program that, when being executed, cause at least one processor to perform: displaying, in a virtual scene, a virtual vehicle and a virtual object located in the virtual vehicle; and controlling, in response to a shooting instruction, the virtual object to shoot toward outside of the virtual vehicle, during a process that the virtual object shoots toward outside of the virtual vehicle, an entirety of the virtual object being located inside the virtual vehicle.

### BRIEF DESCRIPTION OF THE DRAWINGS

FIG. 1 is a schematic diagram of an architecture of a shooting system 100 in a virtual scene according to an embodiment of the present disclosure.

FIG. 2 is a schematic structural diagram of an electronic device according to an embodiment of the present disclosure.

FIG. 3 is a schematic flowchart of a method for shooting in a virtual scene according to an embodiment of the present disclosure.

FIG. 4 is a schematic diagram of a virtual vehicle, a virtual object located in the virtual vehicle, and a shooting control according to an embodiment of the present disclosure.

FIG. 5 is a schematic diagram of a shooting prop in different states according to an embodiment of the present disclosure.

FIG. 6 is a schematic diagram of a shooting prop according to an embodiment of the present disclosure.

FIG. 7 is a schematic flowchart of a process of controlling a virtual object to shoot toward outside of a virtual vehicle according to an embodiment of the present disclosure.

FIG. 8 is a schematic diagram of a process of obtaining a first shooting animation according to an embodiment of the present disclosure.

FIG. 9 is a schematic diagram of a first pose animation and a second pose animation according to an embodiment of the present disclosure.

FIG. 10 is a schematic flowchart of a process of obtaining a state switching animation according to an embodiment of the present disclosure.

FIG. 11 is a schematic diagram of state switching of a shooting prop according to an embodiment of the present disclosure.

FIG. 12 is a technical architecture diagram of a player performing a general operation according to an embodiment of the present disclosure.

FIG. 13 is a schematic diagram of an update procedure of TakeupTime according to an embodiment of the present disclosure.

### DESCRIPTION OF EMBODIMENTS

To make objectives, technical solutions, and advantages of the present disclosure clearer, the following describes embodiments of the present disclosure in further detail with reference to accompanying drawings. The described embodiments are not to be considered as a limitation to the embodiments of the present disclosure. All other embodiments obtained by those of ordinary skill in the art without creative efforts fall within the protection scope of the present disclosure.

In the following descriptions, “some embodiments” is related, which describes a subset of all possible embodiments. However, the “some embodiments” may be the same subset or different subsets of all the possible embodiments, and may be combined with each other without conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of the present disclosure described herein may be performed in an order other than that illustrated or described herein.

Unless otherwise defined, all technical and scientific terms used herein have the same meanings as commonly understood by those skilled in the art belonging to the present disclosure. The terms used herein are merely intended to describe the objectives of the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

(1) “In response to” represents a condition or state on which a performed operation relies. When the condition or state is met, the one or more operations may be performed in real time or have a set delay. Unless otherwise specified, a plurality of performed operations are not limited by an execution sequence.

(2) A client, alternatively referred to as a client side, is a program that corresponds to a server and that provides a local service for a user. In addition to some applications that can only run locally, the client is generally installed on a terminal and needs to run in cooperation with the server. That is, a corresponding server and service program are required to provide a corresponding service in a network. In this way, a specific communication connection needs to be established between the client and a server side to ensure a normal operation of an application, for example, a virtual scene client (for example, a game client).

(3) Artificial intelligence (AI) involves a theory, method, technology, and application system that use a digital computer or a machine controlled by the digital computer to simulate, extend, and expand human intelligence, perceive an environment, obtain knowledge, and use knowledge to obtain an optimal result. In other words, AI is a comprehensive technology in computer science, which attempts to understand the essence of intelligence and produces a new intelligent machine that can react in a manner similar to human intelligence. AI is to study design principles and implementation methods of various intelligent machines, to enable the machines to have the functions of perception, reasoning, and decision-making.

(4) A virtual scene is a virtual scene displayed (or provided) when an application runs on a terminal. The virtual scene may be a simulated environment of the real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene.

For example, the virtual scene may include sky, land, and oceans. The land may include environmental elements such as deserts and cities. A user may control a virtual object to perform an activity in the virtual scene, and the activity includes, but is not limited to: any one of adjusting a body pose, crawling, walking, running, riding, jumping, driving, picking up, shooting, attacking, or throwing. The virtual scene may be a virtual scene displayed from a first-person perspective (for example, the user plays a role of the virtual object in a game from a perspective of the user), may be a virtual scene displayed from a third-person perspective (for example, the user follows the virtual object in the game to play), or may be a virtual scene displayed from an aerial view. The perspectives may be switched freely.

(5) Virtual objects are images of various people and objects that may perform interaction in the virtual scene, or movable objects in the virtual scene. The movable object may be a virtual character, a virtual animal, an animation character, or the like, such as a person, an animal, a plant, an oil drum, a wall, a stone, or a vehicle displayed in the virtual scene. The virtual object may be a virtual image that is virtualized to represent a user in the virtual scene. The virtual scene may include a plurality of virtual objects, and each virtual object has a shape and a volume in the virtual scene, and occupies some space in the virtual scene.

For example, the virtual object may be a user character controlled by operations on a client, may be AI set in a battle in the virtual scene through training, or may be a non-player character (NPC) set in interaction in the virtual scene. A quantity of virtual objects participating in the interaction in the virtual scene may be preset, or may be dynamically determined based on a quantity of clients participating in the interaction.

(6) A third-person perspective is a perspective in which a character and all combat elements in a surrounding environment in a picture can be seen by a camera in a game that is placed at a distance behind a player character.

(7) A first-person perspective is a perspective in which a body part of a character and all combat elements in a surrounding environment in a picture can be seen by a camera in a game that is placed at the eyes of a player character.

(8) A folded and raised state is a solution for dealing with a problem of clipping produced between a shooting prop and an obstacle due to blocking. When blocked by the obstacle, the shooting prop enters the folded and raised state, that is, the shooting prop is first retracted backward by a distance. If a retraction distance is excessively large, the shooting prop is rotated, that is, the shooting prop is turned sideways.

(9) A stowed state is a solution for dealing with a problem of clipping produced between a shooting prop and an internal structure of a car body due to blocking on the vehicle. This problem cannot be resolved well by only using the folded and raised state when the shooting prop and internal structures of the vehicle body penetrate too much. In this case, when a condition is satisfied, a character enters another action of holding the shooting prop, to put down the shooting prop, that is, the stowed state. General operations, such as reloading and shooting, cannot be performed based on the shooting prop in the stowed state.

(10) A virtual camera is a “camera” built in computer animation software or a virtual engine. A function of the virtual camera for representing a viewpoint during animation production is equivalent to a camera. An object photographed by the virtual camera is completely different from an object photographed by a physical camera, but functions of the cameras are quite similar. The physical camera photographs a realistic character or an actually established scene. The virtual camera photographs a model established in three-dimensional software, and can implement infinite possibilities. The virtual camera is presented in a virtual engine in a form of an icon, has parameters such as a lens, a focal length, a focus, an aperture, and a depth of field, can implement camera actions such as “pushing, pulling, shaking, moving, following, throwing, rising, lowering, and comprehensive motion”, and can achieve photographing effects that are difficult or even impossible to be achieved by the physical camera, for example, passing through a wall, passing through a keyhole, and passing through an object. The parameters that need to be adjusted of the physical camera are distributed on a camera body of the physical camera and require manual operation. A camera parameter of the virtual camera is a button or a value input bar integrated in a panel. An operator only needs to enter a parameter or drag a mouse. Sometimes, a motion path of the virtual camera may be determined by using only a few key frames. During actual photographing, the physical camera usually needs to have a stabilizer or a motion control system. However, even in this case, a picture still shakes.

(11) Frame time is the time occupied by one frame.

(12) A pose is a position of a character skeleton, rotation of the character skeleton, and scale information of the character skeleton. The information defines a state of a virtual object in three-dimensional space.

(13) An animation resource is an art resource for animation representation in a game.

(14) Animation superimposition: a difference between two animations may be superimposed onto a new animation.

(15) Animation blending: two animations may be blended into a new animation by using weights, and Transform of a new animation skeleton is a sum of weights of the two skeletons.

(16) Base pose: an initial pose in an entire animation pipeline is generally referred to as a base pose, and various superpositions may be performed subsequently.

(17) Superimposition animation resource: an animation resource obtained by making a difference between two animations during animation superposition is a superimposition animation resource.

Embodiments of the present disclosure provide a method and apparatus for shooting in a virtual scene, an electronic device, a computer-readable storage medium, and a computer program product, which can improve efficiency of performing a shooting operation in a virtual scene, human-computer interaction efficiency, and utilization of hardware processing resources.

FIG. 1 is a schematic diagram of an architecture of a shooting system 100 in a virtual scene according to an embodiment of the present disclosure. A terminal (for example, a terminal 400) is connected to a server 200 by using a network 300. The network 300 may be a wide area network or a local area network, or a combination thereof. Data transmission is implemented by using a wireless or wired link.

The server 200 is configured to transmit scene data corresponding to a virtual scene including a virtual vehicle and a virtual object located in the virtual vehicle to the terminal 400.

The terminal 400 is configured to: receive the scene data corresponding to the virtual scene including the virtual vehicle and the virtual object located in the virtual vehicle; display the virtual scene based on the scene data; display, in the virtual scene, the virtual vehicle and the virtual object located in the virtual vehicle; and control, in response to a shooting instruction, the virtual object to shoot toward outside of the virtual vehicle, in a process in which the virtual object shoots toward outside of the virtual vehicle, the virtual object being wholly located inside the virtual vehicle.

In some embodiments, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content deliver network (CDN), big data, and an AI platform. The terminal 400 may be a smartphone, a tablet computer, a laptop, a desktop computer, a set-top box, an intelligent voice interaction device, a smart home appliance, a virtual reality device, an on-board terminal, an aircraft, a portable music player, a personal digital assistant, a dedicated messaging device, a portable gaming device, a smart speaker, a smart watch, and the like, but is not limited thereto. The terminal and the server may be connected directly or indirectly in a wired or wireless communication protocol. This is not limited in the embodiments of the present disclosure.

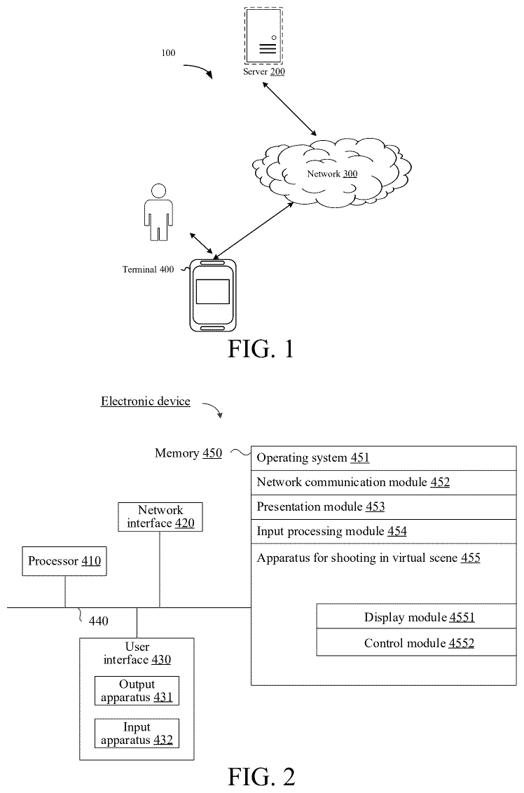

Next, an electronic device that implements the method for shooting in a virtual scene according to the embodiments of the present disclosure is described. FIG. 2 is a schematic structural diagram of an electronic device according to an embodiment of the present disclosure. The electronic device may be a server or a terminal. Using an example in which the electronic device is the terminal shown in FIG. 1, the electronic device shown in FIG. 2 includes: at least one processor 410, a memory 450, at least one network interface 420, and a user interface 430. Components in the terminal 400 are coupled together by using a bus system 440. The bus system 440 is configured to implement connection and communication between the components. In addition to a data bus, the bus system 440 further includes a power bus, a control bus, and a state signal bus. However, for clarity of description, various buses are marked as the bus system 440 in FIG. 2.

The processor 410 may be an integrated circuit chip with a signal processing capability, such as a general-purpose processor, a digital signal processor (DSP), or another programmable logic device (PLD), a discrete gate, a transistor logic device, or a discrete hardware component. The general-purpose processor may be a microprocessor, any conventional processor, or the like.

The user interface 430 includes one or more output apparatuses 431 that can display media content, which includes one or more speakers and/or one/more visual display screens. The user interface 430 further includes one or more input apparatuses 432, which includes a user interface component that facilitates user input, for example, a keyboard, a mouse, a microphone, a touch display screen, a camera, and other input buttons and controls.

The memory 450 may be removable, irremovable or a combination thereof. An exemplary hardware device includes a solid memory, a hard disk drive, an optical disk drive, and the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of the present disclosure aims to include any suitable type of memories.

In some embodiments, the memory 450 can store data to support various operations. Examples of the data include a program, a module, a data structure, or a subset or a superset thereof, which are exemplarily described below.

An operating system 451 includes system programs configured for processing various basic system services and performing hardware related tasks, for example, a frame layer, a core library layer, and a drive layer, and is configured to implement various basic services and process hardware-based tasks.

A network communication module 452 is configured to reach another electronic device via one or more (wired or wireless) network interfaces 420. An exemplary network interface 420 includes: Bluetooth, wireless fidelity (Wi-Fi), a universal serial bus (USB), and the like.

A presentation module 453 is configured to display information via one or more output apparatuses 431 (for example, a display and a speaker) associated with the user interface 430 (for example, a user interface configured to operate a peripheral device and display content and information).

An input processing module 454 is configured to detect one or more user inputs or interactions from the input apparatus 432 and translate a detected input or interaction.

In some embodiments, the apparatus according to the embodiments of the present disclosure may be implemented by software. FIG. 2 shows an apparatus 455 for shooting in a virtual scene stored in a memory 450, which may be software in a form of a program and a plug-in, and includes the following software modules: a display module 4551 and a control module 4552. These modules are logical and may be arbitrarily combined or further split according to implemented functions. Functions of the modules are described below.

In some other embodiments, the apparatus according to the embodiments of the present disclosure may be implemented in hardware. As an example, the apparatus for shooting in a virtual scene according to the embodiments of the present disclosure may be a processor in the form of a hardware decoding processor, and may be programmed to perform the method for shooting in a virtual scene according to the embodiments of the present disclosure. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some embodiments, the terminal or the server may implement the method for shooting in a virtual scene according to the embodiments of the present disclosure by running a computer program. For example, the computer program may be a native program or a software module in an operating system, may be a native application (APP), that is, a local client, that is, a program that needs to be installed in an operating system for running, such as an instant messaging APP and a web page browser APP, or may be an applet, that is, a program that can run by downloading into a browser environment, or may be an applet that can be embedded in any APP. In conclusion, the foregoing computer program may be a client, a module, or a plug-in in any form.

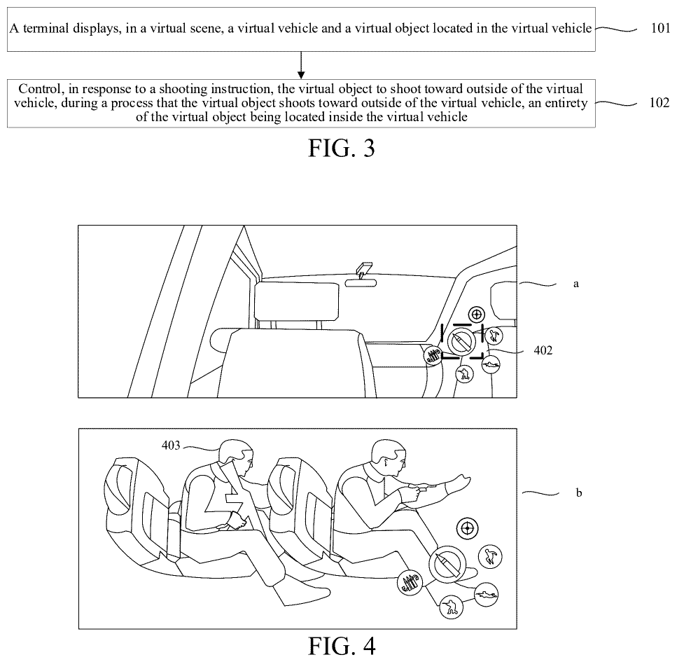

Based on the foregoing descriptions of a shooting system in a virtual scene and an electronic device according to the embodiments of the present disclosure. The method for shooting in a virtual scene according to the embodiments of the present disclosure is described below. During actual implementations, the method for shooting in a virtual scene according to the embodiments of the present disclosure may be independently implemented by a terminal or a server, or may be collaboratively implemented by a terminal and a server. An example in which the server 400 in FIG. 1 independently performs the method for shooting in a virtual scene according to the embodiments of the present disclosure is used for description. FIG. 3 is a schematic flowchart of a method for shooting in a virtual scene according to the embodiments of the present disclosure, which is then described in combination with operations shown in FIG. 3.

Operation 101: A terminal displays, in a virtual scene, a virtual vehicle and a virtual object located in the virtual vehicle.

During actual implementations, an application supporting the virtual scene is run on the terminal. The application may be any one of a first-person shooting game, a third-person shooting game, a multiplayer online tactical arena game, a virtual reality application, a three-dimensional map program, or a multiplayer gunfight survival game. A user may operate the virtual object located in the virtual scene by using the terminal to perform activities.

When the user opens the application on the terminal, and the terminal runs the application, the terminal presents a picture of a virtual scene (for example, a driving game scene). The picture of the virtual scene herein is obtained by observing the virtual scene from a first-person object perspective, or is obtained by observing the virtual scene from a third-person perspective. The picture of the virtual scene includes a virtual object. The virtual object may be a player character controlled by a current player, or may be a player character controlled by another player (teammate) belonging to the same group as the current player. The virtual vehicle may assist the player character in moving in the virtual scene. Common virtual vehicles include a virtual car, a virtual ship, a virtual aircraft, and the like. This is not limited in this embodiment of the present disclosure.

The virtual object located in the virtual vehicle may further perform a projection operation, including a throwing operation and a shooting operation, inside the virtual vehicle, for example, perform the shooting operation by using a displayed shooting control. For example, in the virtual scene, the virtual vehicle and the virtual object located in the virtual vehicle are displayed, and the shooting control is displayed. For example, FIG. 4 is a schematic diagram of a virtual vehicle, a virtual object located in the virtual vehicle, and a shooting control according to an embodiment of the present disclosure. Based on FIG. 4, picture a in FIG. 4 is obtained by observing the virtual scene from the first-person perspective of the virtual object. A dashed box 401 indicates the shooting control. Picture b in FIG. 4 is obtained by observing the virtual scene from the third-person perspective of the virtual object. A dashed box 402 indicates the shooting control, and 403 indicates the virtual object.

During actual implementations, a virtual object is equipped with a shooting prop. When the virtual object is located inside a virtual vehicle, the shooting prop is in a stowed state or a raised state. The stowed state indicates that the shooting prop is in a standby state or an unused state, for example, a state in which the virtual object carries the shooting prop at the back, or a state in which the virtual object places the shooting prop on the legs or in a virtual backpack, or a state in which the virtual object places the shooting prop on a seat of the virtual vehicle. The raised state includes a folded and raised state and a normally raised state, and indicates that the shooting prop is in a state of waiting to be used, for example, an aiming state. A distance between the shooting prop in the folded and raised state and the virtual object is less than a distance between the shooting prop in the normally raised state and the virtual object. In this way, a problem of clipping with an obstacle in front when the shooting prop is raised is avoided by using the folded state.

In addition, the folded and raised state includes a backward folded state and a rotated and folded state, where a distance between the shooting prop in the backward folded and raised state and the virtual object is less than a distance between the shooting prop in the normally raised state and the virtual object; and a distance between the shooting prop in the rotated, folded, and raised state and the virtual object is less than a distance between the shooting prop in the normally raised state and the virtual object, and is rotated compared with the shooting prop in the normally raised state.

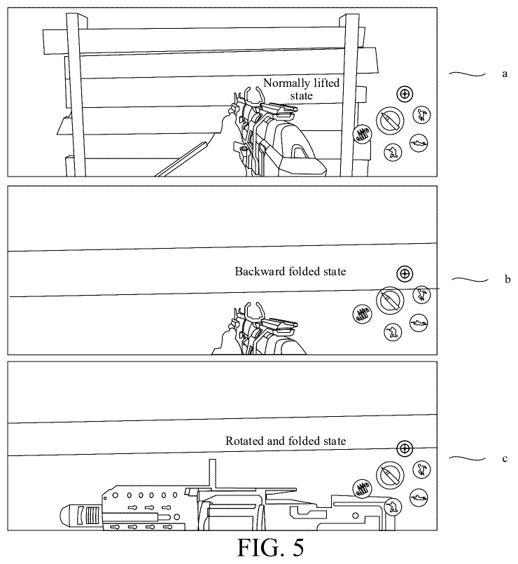

For example, FIG. 5 is a schematic diagram of a shooting prop in different states according to an embodiment of the present disclosure. Based on FIG. 5, the shooting prop in a of FIG. 5 is in a normally raised state, the shooting prop in b of FIG. 5 is in a backward folded state, and the shooting prop in c of FIG. 5 is in a rotated and folded state.

An operation process of the shooting prop in the raised state mentioned in this embodiment of the present disclosure indicates that the shooting prop may perform a corresponding shooting operation or aiming operation process when the shooting prop is in the folded and raised state or the normally raised state. Correspondingly, an operation process of the shooting prop in the folded and raised state mentioned in this embodiment of the present disclosure indicates that the shooting prop may perform a corresponding shooting operation or aiming operation process when the shooting prop is in the backward folded state or the rotated and folded state.

During actual implementations, before a virtual object enters a virtual vehicle, the virtual object is equipped with a shooting prop, and the shooting prop may be in a raised state, or may be in a stowed state. When the virtual object is located at a co-pilot position of the virtual vehicle after entering the virtual vehicle, no matter which state of the shooting prop equipped on the virtual object outside the virtual vehicle is, after the virtual object enters the virtual vehicle, the shooting prop is in the raised state by default. After the virtual object enters the virtual vehicle, if the virtual object is located at a rear position of the virtual vehicle, that is, a non-driving position and a non-co-pilot position, no matter which state of the shooting prop equipped on the virtual object outside the virtual vehicle is, after the virtual object enters the virtual vehicle, the shooting prop is in the stowed state by default.

In some embodiments, as described above, after the virtual object enters the virtual vehicle, if the virtual object is located at the rear position of the virtual vehicle, that is, the non-driving position and the non-co-pilot position, the shooting prop is in the stowed state by default, that is, the virtual object is equipped with the shooting prop, and the shooting prop is in the stowed state. In this case, perspective conversion may further be performed on the virtual object to switch a perspective of the virtual object, and the virtual object is controlled to perform the perspective conversion in response to a perspective conversion instruction for the virtual object; when an orientation of the virtual object on which the perspective conversion has been performed is not within a target angle range, the virtual object is controlled to switch the state of the shooting prop from the stowed state to the raised state; and therefore, a subsequent process of controlling, in response to a shooting instruction, the virtual object to shoot toward outside of the virtual vehicle may be: controlling, in response to the shooting instruction, the virtual object to shoot toward outside of the virtual vehicle by using the shooting prop in the raised state.

The target angle range is preset. When the virtual object enters the virtual vehicle, a coordinate system is constructed by using the virtual object as an origin and a driving direction of the virtual vehicle as a vertical coordinate axis. After the virtual object is controlled to perform the perspective conversion in response to the perspective conversion instruction for the virtual object, an angle corresponding to the orientation of the virtual object on which the perspective conversion has been performed is obtained based on the constructed coordinate system, and whether the angle is within the target angle range is determined. Therefore, when the angle is not within the target angle range, the virtual object is controlled to switch the state of the shooting prop from the stowed state to the raised state. When the angle is within the target angle range, the virtual object is controlled to remain the state of the shooting prop in the stowed state. The angle corresponding to the orientation herein is an included angle between the orientation and a vertical coordinate. In addition, the target angle range may alternatively be preset, for example, 0 degree to 45 degrees.

The orientation of the virtual object within the target angle range indicates that the virtual object faces the inside of the virtual vehicle, and it indicates that the virtual object is not intended to shoot toward outside of the virtual vehicle. Therefore, the virtual object is controlled to remain the state of the shooting prop in the stowed state. The orientation of the virtual object not within the target angle range indicates that the virtual object faces outside the virtual vehicle, and it indicates that the virtual object is intended to shoot toward outside of the virtual vehicle. Therefore, the virtual object is controlled to switch the state of the shooting prop from the stowed state to the raised state, thereby facilitating shooting toward outside of the virtual vehicle by the virtual object.

By applying the foregoing embodiment, when the shooting prop is in the stowed state, if perspective conversion is performed on the virtual object, whether the virtual object needs to lift the shooting prop may be determined according to a perspective conversion angle of the virtual object. If the virtual object faces the inside of the virtual vehicle, it indicates that the virtual object is not intended to shoot toward outside of the virtual vehicle, and the shooting prop does not need to be raised. If the virtual object faces outside the virtual vehicle, it indicates that the virtual object is intended to shoot toward outside of the virtual vehicle, and the shooting prop needs to be raised. Based on this, whether the state of the shooting prop needs to be switched from the stowed state to the raised state is determined, thereby facilitating shooting toward outside of the virtual vehicle by the virtual object, and improving efficiency of performing a shooting operation and human-computer interaction efficiency.

During actual implementations, as described above, the raised state includes the folded and raised state, and the distance between the shooting prop in the folded and raised state and the virtual object is less than the distance between the shooting prop in the normally raised state and the virtual object. Therefore, a process of controlling, when the orientation of the virtual object on which the perspective conversion has been performed is not within the target angle range, the virtual object to switch the state of the shooting prop from the stowed state to the raised state may be: controlling, when the orientation of the virtual object on which the perspective conversion has been performed in not within the target angle range, the virtual object to switch the state of the shooting prop from the stowed state to the folded and raised state in response to that there is an obstacle directly in front of the virtual object. Therefore, the process of controlling, in response to the shooting instruction, the virtual object to shoot toward outside of the virtual vehicle by using the shooting prop in the raised state may be: controlling, in response to the shooting instruction, the virtual object to shoot toward outside of the virtual vehicle by using the shooting prop in the folded and raised state.

The obstacle directly in front of the virtual object may be, for example, glass on two sides of the rear position of the virtual vehicle, and the “directly in front of the virtual object” refers to a current orientation of the virtual object or a direction of time, thereby controlling the virtual object to switch the state of the shooting prop from the stowed state to the folded and raised state when there is an obstacle directly in front of the virtual object, and then to shoot. In this way, when an obstacle appears directly in front of the virtual object, a problem of clipping with an obstacle in front when the shooting prop is raised is avoided by using the folded state, thereby improving immersion and game experience of a player.

Alternatively, when the orientation of the virtual object on which the perspective conversion has been performed is not within the target angle range, the virtual object is controlled to switch the state of the shooting prop from the stowed state to the normally raised state in response to that there is no obstacle directly in front of the virtual object. Therefore, the process of controlling, in response to the shooting instruction, the virtual object to shoot toward outside of the virtual vehicle by using the shooting prop in the raised state may be: controlling, in response to the shooting instruction, the virtual object to shoot toward outside of the virtual vehicle by using the shooting prop in the normally raised state.

During actual implementations, changes in states of the shooting prop are described above after the virtual object enters the virtual vehicle. For example, if the virtual object equipped with the shooting prop is located at the rear position of the virtual vehicle after entering the virtual vehicle, the shooting prop is in the stowed state; or if the virtual object equipped with the shooting prop is located at a co-pilot position of the virtual vehicle after entering the virtual vehicle, the shooting prop is in the raised state. Before the virtual object enters the virtual vehicle, the shooting prop includes the stowed state and the raised state. Therefore, before the virtual object enters the virtual vehicle, the changes in the states of the shooting prop exist. Next, the process of displaying the virtual vehicle and the virtual object located in the virtual vehicle in the virtual scene is described by using two state changes as an example.

In some embodiments, when the shooting prop equipped on the virtual object outside the virtual vehicle is in the raised state, and the virtual object is located at the rear position of the virtual vehicle after entering the virtual vehicle, a process of displaying, in the virtual scene, the virtual vehicle and the virtual object located in the virtual vehicle may be: displaying the virtual vehicle and the virtual object located outside the virtual vehicle in the virtual scene, when the virtual object is located outside the virtual vehicle, the shooting prop equipped on the virtual object being in the raised state; and controlling, in response to a vehicle entering instruction for the virtual object, the virtual object to enter the virtual vehicle, and controlling the virtual object to switch the state of the shooting prop from the raised state to the stowed state.

Because a front seat is in front of the rear position, when the virtual object is located at the rear position after entering the virtual vehicle, the shooting prop is in the stowed state by default, and then whether the state of the shooting prop changes, for example, remains in the stowed state, or changes from the stowed state to the raised state, is determined based on the foregoing perspective conversion process. Details are not described herein again.

In some other embodiments, when the shooting prop equipped on the virtual object outside the virtual vehicle is in the stowed state, and the virtual object is located at the co-pilot position of the virtual vehicle after entering the virtual vehicle, the virtual object is equipped with the shooting prop, and the process of displaying, in the virtual scene, the virtual vehicle and the virtual object located in the virtual vehicle may be: displaying, in the virtual scene, the virtual vehicle and the virtual object located outside the virtual vehicle, when the virtual object is located outside the virtual vehicle, the shooting prop equipped on the virtual object being in the stowed state; and controlling, in response to the vehicle entering instruction for the virtual object, the virtual object to enter the virtual vehicle, and controlling the virtual object to switch the state of the shooting prop from the stowed state to the raised state.

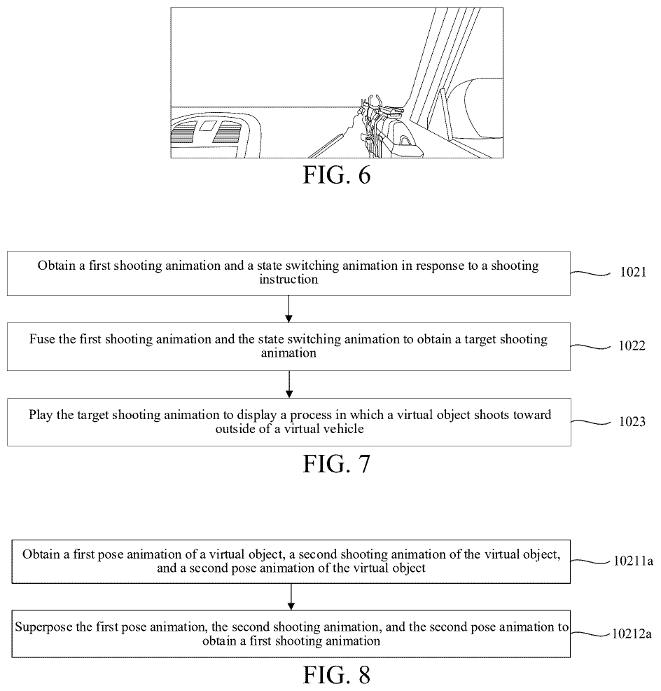

For example, FIG. 6 is a schematic diagram of a shooting prop according to an embodiment of the present disclosure. Based on FIG. 6, when a shooting prop equipped on a virtual object outside a virtual vehicle is in a stowed state, and the virtual object is located at a co-pilot position of the virtual vehicle after entering the virtual vehicle, the virtual object is controlled to switch a state of the shooting prop from the stowed state to a raised state shown in FIG. 6.

As described above, because the front seat in front of the rear position, when the virtual object is located at the rear position after entering the virtual vehicle, the shooting prop is in the stowed state by default. Glass is in front of the co-pilot position for observing outside the virtual vehicle and shooting. Therefore, when the virtual object is located at the co-pilot position after entering the virtual vehicle, the shooting prop is in the raised state by default.

In actual applications, by defining a state change process of the shooting prop before and after the virtual object enters the virtual vehicle, a process that the virtual object enters the virtual vehicle is smoother, thereby improving immersion and game experience of a player, and improving utilization of resources in a virtual scene.

In addition, as described above, the raised state includes the folded and raised state, and the distance between the shooting prop in the folded and raised state and the virtual object is less than the distance between the shooting prop in the normally raised state and the virtual object. Therefore, when controlling, in response to the vehicle entering instruction for the virtual object, the virtual object to enter the virtual vehicle, and controlling the virtual object to switch the state of the shooting prop from the stowed state to the raised state, the process of controlling the virtual object to switch the state of the shooting prop from the stowed state to the raised state may be: controlling, when there is an obstacle directly in front of the virtual object, the virtual object to switch the state of the shooting prop from the stowed state to the folded and raised state; and controlling, when there is no obstacle directly in front of the virtual object, the virtual object to switch the state of the shooting prop from the stowed state to the normally raised state.

In addition, when the perspective conversion is performed on the virtual object, the virtual object is controlled to perform the perspective conversion in response to a perspective conversion instruction for the virtual object. If there is no obstacle directly in front of the virtual object, the virtual object is controlled to place the shooting prop in the normally raised state, for example, remaining in the normally raised state (that is, there is no obstacle directly in front of the virtual object before the perspective conversion) or the virtual object is controlled to switch the state of the shooting prop from the folded and raised state to the normally raised state (that is, there is an obstacle directly in front of the virtual object before the perspective conversion, and the shooting prop is originally in the folded and raised state), or if there is an obstacle directly in front of the virtual object, the virtual object is controlled to place the shooting prop in the folded and raised state, for example, remaining in the folded and raised state (that is, there is an obstacle directly in front of the virtual object before the perspective conversion) or the virtual object is controlled to switch the state of the shooting prop from the normally raised state to the folded and raised state (that is, there is no obstacle directly in front of the virtual object before the perspective conversion, and the shooting prop is originally in the normally raised state).

A process of determining the state of the shooting prop based on whether the orientation of the virtual object is within the target angle range is for the virtual object located at the rear position. Because the shooting prop equipped on the virtual object located at the co-pilot position is in the raised state, no matter whether the orientation of the virtual object located at the co-pilot position is within the target angle range, the shooting prop of the virtual object is in the raised state, and whether the raised state of the shooting prop is the normally raised state or the folded and raised state is only determined based on whether there is an obstacle directly in front of the virtual object.

For example, if the virtual vehicle is a car, and when the virtual object is located at a co-pilot position, the obstacle in front of the virtual object may be a windscreen directly in front of the virtual object before the perspective conversion, or may be a side glass directly in front of the virtual object after the perspective conversion. When the virtual object is located at a rear position, the obstacle in front of the virtual object may be a seat directly in front of the virtual object before the perspective conversion, or may be a side glass directly in front of the virtual object after the perspective conversion.

The obstacle is determined based on a length of the shooting prop and a distance between the virtual object and another object. A process of determining the obstacle is described below. Details are not described herein again.

During actual implementations, as described above, after the virtual vehicle and the virtual object located in the virtual vehicle are displayed in the virtual scene, no matter whether the virtual object is located at the co-pilot position or the rear position, or whether the perspective conversion is performed, the virtual object is controlled to place the shooting prop in the folded and raised state when an obstacle is directly in front of the virtual object. As described above, the distance between the shooting prop in the folded and raised state and the virtual object is less than the distance between the shooting prop in the normally raised state and the virtual object. Therefore, the subsequent process of controlling, in response to the shooting instruction, the virtual object to shoot toward outside of the virtual vehicle may be: controlling, in response to the shooting instruction, the virtual object to shoot toward outside of the virtual vehicle by using the shooting prop in the folded and raised state.

When the virtual object is located at the rear position, and when an obstacle is directly in front of the virtual object, the process of controlling the virtual object to place the shooting prop in the folded and raised state is as described above. After the virtual object is controlled perform the perspective conversion, if the orientation of the virtual object is not within the target angle range, the virtual object is controlled to switch the state of the shooting prop from the stowed state to the folded and raised state; and if the orientation of the virtual object is within the target angle range, the virtual object is controlled to remain the state of the shooting prop in the stowed state.

When the virtual object is located at the co-pilot position, if there is an obstacle directly in front of the virtual object when the virtual object enters the virtual vehicle, the process of controlling the virtual object to place the shooting prop in the folded and raised state is as described above. If the perspective conversion is not performed on the virtual object, and there is an obstacle directly in front of the virtual object, the shooting prop is in the folded and raised state by default, or as described above, if the prospective conversion is performed on the virtual object, and there is an obstacle directly in front of the virtual object, the folded and raised state is remained or the virtual object is controlled to switch the state of the shooting prop from the normally raised state to the folded and raised state.

By applying the foregoing embodiment, when there is an obstacle directly in front of the virtual object, the virtual object is controlled to place the shooting prop in the folded and raised state, and then to shoot. In this way, when an obstacle appears directly in front of the virtual object, a problem of clipping with the obstacle in front when the shooting prop is raised is avoided by using the folded and raised state. In addition, a player can prepare to shoot, thereby not only improving immersion and game experience of the player, but also improving efficiency of performing a shooting operation.

In some embodiments, before subsequently controlling, in response to the shooting instruction, the virtual object to shoot toward outside of the virtual vehicle, the virtual object may further be controlled to aim at the outside of the virtual vehicle in response to an aiming instruction for the outside of the virtual vehicle, thereby controlling, in response to the shooting instruction, the virtual object to shoot toward outside of the virtual vehicle after aiming.

The aiming instruction may be triggered by a perspective conversion operation for the virtual object. That is, the aiming instruction may be considered as the foregoing perspective conversion instruction. For example, a perspective conversion process is used as an aiming process (for example, when a scope is not required for aiming); alternatively, the aiming instruction may be triggered based on an aiming control. For example, before the perspective conversion process or after the perspective conversion process, the aiming instruction is received (for example, when a scope is required for aiming) in response to a trigger operation for the aiming control.

In some embodiments, if the shooting prop is in the stowed state, the process of controlling, in response to the aiming instruction for the outside of the virtual vehicle, the virtual object to aim at the outside of the virtual vehicle may be: controlling, in response to the aiming instruction for the outside of the virtual vehicle when the shooting prop of the virtual object is in the stowed state, the virtual object to gradually switch the state of the shooting prop from the stowed state to the raised state; and controlling, in a process of switching the state of the shooting prop from the stowed state to the raised state, the virtual object to aim at the outside of the virtual vehicle.

In some other embodiments, if the shooting prop is in the raised state, the process of controlling, in response to the aiming instruction for the outside of the virtual vehicle, the virtual object to aim at the outside of the virtual vehicle may be: directly controlling, in response to the aiming instruction for the outside of the virtual vehicle, the virtual object to aim at the outside of the virtual vehicle when the shooting prop of the virtual object is in the raised state.

In some embodiments, the virtual object performs shooting toward outside of the virtual vehicle based on the shooting prop. Before subsequently controlling, in response to the shooting instruction, the virtual object to shoot toward outside of the virtual vehicle, the virtual object may further be controlled, in response to a component configuration operation for the shooting prop, to configure a key component of the shooting prop, the key component of the shooting prop including at least one of the following: a scope, a virtual sub-prop corresponding to the shooting prop, a muffler, and a virtual stock.

The scope herein may be a 2× scope, a 4× scope, a 6× scope, an 8× scope, or the like. The virtual sub-prop may be a virtual bullet corresponding to the shooting prop, whereby the component configuration operation for the shooting prop may be a reloading operation for the shooting prop, or an assembly operation for the scope, the virtual stock, and the muffler, or the like.

In actual applications, when the virtual object is located inside the virtual vehicle, component configuration of the shooting prop may further be performed, thereby not only improving player experience and human-computer interaction efficiency, but also improving utilization of hardware resources.

During actual implementations, the process of controlling, in response to a configuration operation for the shooting prop, the virtual object to configure a component of the shooting prop may be: controlling, in response to the configuration operation for the shooting prop when the shooting prop of the virtual object is in the stowed state, the virtual object to gradually switch the state of the shooting prop from the stowed state to the raised state; and controlling the virtual object to configure the component of the shooting prop in the process of switching the state of the shooting prop from the stowed state to the raised state.

When the virtual object configures the shooting prop, the shooting prop needs to be in a raised state. When a configuration operation for the shooting prop in the raised state is received, the virtual object is directly controlled to configure a component of the shooting prop; when a configuration operation for the shooting prop in the stowed state is received, the virtual object is automatically controlled to gradually switch the state of the shooting prop from the stowed state to the raised state; and the virtual object is controlled to configure the component of the shooting prop in the process of switching the state of the shooting prop from the stowed state to the raised state.

In this way, compared with a solution in a related art in which the shooting prop in the stowed state needs to be first raised, and then the shooting prop is configured, in the present disclosure, the virtual object is controlled to configure the component of the shooting prop in the process of switching the state of the shooting prop from the stowed state to the raised state, thereby shortening a time for configuring the component of the shooting prop, improving efficiency of configuring the component of the shooting prop, reducing an operation of controlling the virtual object to switch the state of the shooting prop from the stowed state to the raised state by a user, and improving human-computer interaction efficiency.

In some embodiments, the virtual object performs shooting toward outside of the virtual vehicle based on the shooting prop, and the shooting prop includes at least one key component. Alternatively, a state of each key component of the shooting prop may be detected to obtain a detection result, the state including a normal state and a target state for configuration. Configuration prompt information is displayed when the detection result represents that a target key component of the at least one key component is in the target state for configuration, the configuration prompt information being configured for prompting to configure the target key component.

As described above, the key component of the shooting prop includes at least one of the following: a scope, a virtual sub-prop corresponding to the shooting prop, a muffler, and a virtual stock. For the scope, the normal state is configured for indicating that the shooting prop is equipped with the scope, and the target state for configuration is configured for indicating that the shooting prop is not equipped with the scope. For the virtual sub-prop, the normal state is configured for indicating that the virtual sub-prop loaded on the shooting prop reaches a maximum capacity, and the target state for configuration is configured for indicating that the virtual sub-prop loaded on the shooting prop does not reach a maximum capacity, and may further be loaded continuously. For the muffler, the normal state is configured for indicating that the shooting prop is equipped with the muffler, and the target state for configuration is configured for indicating that the shooting prop is not equipped with the muffler. For the virtual stock, the normal state is configured for indicating that the shooting prop is equipped with the virtual stock, and the target state for configuration is configured for indicating that the shooting prop is not equipped with the virtual stock.

During actual implementations, a moment of detecting the state of each key component of the shooting prop may be that the state of each key component of the shooting prop is detected each time a shooting operation is performed, or a user manually triggers a process of detecting the state of each key component of the shooting prop. This is not limited in this embodiment of the present disclosure.

By applying the foregoing embodiment, by detecting the state of each key component of the shooting prop, a to-be-configured key component is determined, and then the to-be-configured key component is configured. In this way, a player clearly senses the state of each key component, thereby facilitating determining which key component needs to be configured by the player, not only reducing difficulty in a game and improving ease of game play, but also improving game experience of the player, human-computer interaction efficiency, and utilization of hardware resources of an electronic device.

Operation 102: Control, in response to a shooting instruction, the virtual object to shoot toward outside of the virtual vehicle, in a process in which the virtual object shoots toward outside of the virtual vehicle, the virtual object being wholly located inside the virtual vehicle.

As described above, a shooting control may further be displayed. Therefore, the shooting instruction is triggered by a click operation on the shooting control, or the shooting instruction may be triggered by using at least one of a keyboard, a mouse, or a joystick. This is not limited in this embodiment of the present disclosure. The virtual object being wholly located inside the virtual vehicle indicates that the whole body of the virtual object is located inside the virtual vehicle. Controlling the virtual object to shoot toward outside of the virtual vehicle may be shooting a second virtual object outside the virtual vehicle, or directly shooting toward outside of the virtual vehicle. This is not limited in this embodiment of the present disclosure.

When controlling the virtual object to shoot toward outside of the virtual vehicle is to shoot a second virtual object outside the virtual vehicle, the second virtual object may be a player character controlled by another player in an enemy camp with the player character controlled by a current player, may be an AI-controlled object in the virtual scene for the player to interact, an NPC in the virtual scene, or the like.

In some embodiments, the virtual object is equipped with a shooting prop, the orientation of the virtual object is within the target angle range, and the virtual object may further be controlled to place the shooting prop in the stowed state. Therefore, the process of controlling, in response to the shooting instruction, the virtual object to shoot toward outside of the virtual vehicle may be: controlling, in response to the shooting instruction, the virtual object to gradually switch the state of the shooting prop from the stowed state to the raised state; and controlling, in a process of switching the state of the shooting prop from the stowed state to the raised state, the virtual object to shoot toward outside of the virtual vehicle by using the shooting prop.

As described above, the target angle range is preset. When the virtual object is located inside the virtual vehicle, a coordinate system is constructed by using the virtual object as an origin and a driving direction of the virtual vehicle as a vertical coordinate axis, then an angle corresponding to an orientation of the virtual object is obtained based on the constructed coordinate system, and whether the angle is within the target angle range is determined, thereby controlling the shooting prop of the virtual object to be in the stowed state when the orientation of the virtual object is within the target angle range. As described above, a current orientation of the virtual object may be an orientation of the virtual object on which the perspective conversion has been performed, or may be an orientation of the virtual object on which the perspective conversion has not been performed. In addition, before the virtual object is controlled to place the shooting prop in the stowed state, the shooting prop of the virtual object may be in the raised state, or may be in the stowed state.

When the virtual object shoots toward outside of the virtual vehicle, the shooting prop needs to be in a raised state. The shooting instruction is received when the shooting prop is in the raised state, and then the virtual object is directly controlled to shoot toward outside of the virtual vehicle; the shooting instruction is received when the shooting prop is in the stowed state, and then the virtual object is automatically controlled to gradually switch the state of the shooting prop from the stowed state to the raised state; and the virtual object is controlled to shoot toward outside of the virtual vehicle in a process of switching the state of the shooting prop from the stowed state to the raised state.

In actual applications, compared with a solution in a related art in which a virtual object needs to shoot an enemy after lifting a shooting prop in a stowed state, and needs to first lean out and then shoot the enemy, in the present disclosure, in the process of switching the state of the shooting prop from the stowed state to the raised state, the virtual object is controlled to shoot toward outside of the virtual vehicle, thereby reducing an operation of controlling the virtual object to switch the state of the shooting prop from the stowed state to the raised state and an operation of leaning out performed by a user, and improving human-computer interaction efficiency.

During actual implementations, after the virtual object is controlled to shoot toward outside of the virtual vehicle by using the shooting prop, the virtual object may further be controlled to switch the state of the shooting prop from the raised state to the stowed state when the virtual object completes shooting toward outside of the virtual vehicle.

In a process in which the virtual object completes shooting toward outside of the virtual vehicle, if the orientation of the virtual object is always within the target angle range, shooting completion duration is displayed. The shooting completion duration is configured for indicating duration from an end moment of the shooting operation to a current moment. When the shooting completion duration reaches target completion duration, the virtual object is automatically controlled to switch the state of the shooting prop from the raised state to the stowed state. If the orientation of the virtual object changes and is not within the target angle range, the virtual object is controlled to place the shooting prop in the raised state.

By applying the foregoing embodiment, if the virtual object completes shooting toward outside of the virtual vehicle, the state of the shooting prop may further be automatically switched from the raised state to the stowed state. In this way, the shooting prop is automatically switched to the original stowed state, thereby reducing an operation of manually switching the shooting prop from the raised state to the stowed state, not only improving human-computer interaction efficiency, but also improving player experience.

In actual implementations, as described above, the shooting instruction is received when the shooting prop is in the raised state, then the virtual object is directly controlled to shoot toward outside of the virtual vehicle; the shooting instruction is received when the shooting prop is in the stowed state, then the virtual object is automatically controlled to gradually switch the state of the shooting prop from the stowed state to the raised state; and the virtual object is controlled to shoot toward outside of the virtual vehicle in a process of switching the state of the shooting prop from the stowed state to the raised state. Next, based on the foregoing two cases, the process of controlling, in response to the shooting instruction, the virtual object to shoot toward outside of the virtual vehicle is described.

In some embodiments, the virtual object is equipped with a shooting prop, and the shooting prop is in a stowed state. FIG. 7 is a schematic flowchart of a process of controlling a virtual object to shoot toward outside of a virtual vehicle according to an embodiment of the present disclosure. Based on FIG. 7, operation 102 may be implemented by the following operations.

Operation 1021: Obtain a first shooting animation and a state switching animation in response to a shooting instruction,
the first shooting animation being configured for indicating a process of performing a shooting operation by using the shooting prop in the raised state when the virtual object is located inside the virtual vehicle, and the state switching animation being configured for indicating a process in which the virtual object switches the state of the shooting prop from the stowed state to the raised state in the virtual vehicle.

Animation duration of the first shooting animation is the same as that of the state switching animation, and quantities of image frames included in the first shooting animation and the state switching animation are the same. That is, a frame rate of the first shooting animation is the same as that of the state switching animation.

During actual implementations, for a process of obtaining the first shooting animation, refer to FIG. 8, which is a schematic diagram of a process of obtaining a first shooting animation according to an embodiment of the present disclosure. Based on FIG. 8, the process of obtaining the first shooting animation according to an embodiment of the present disclosure may be implemented by the following operations.

Operation 10211a: Obtain a first pose animation of a virtual object, a second shooting animation of the virtual object, and a second pose animation of the virtual object,
the first pose animation being configured for indicating a pose for equipping the shooting prop in the raised state when the virtual object is located outside the virtual vehicle, the second shooting animation being configured for indicating a process of performing the shooting operation by using the shooting prop in the raised state when the virtual object is located outside the virtual vehicle, the second pose animation being configured for indicating a pose for equipping the shooting prop in the raised state when the virtual object is located inside the virtual vehicle, and the virtual object in the first pose animation and the virtual object in the second pose animation having the same upper body pose.

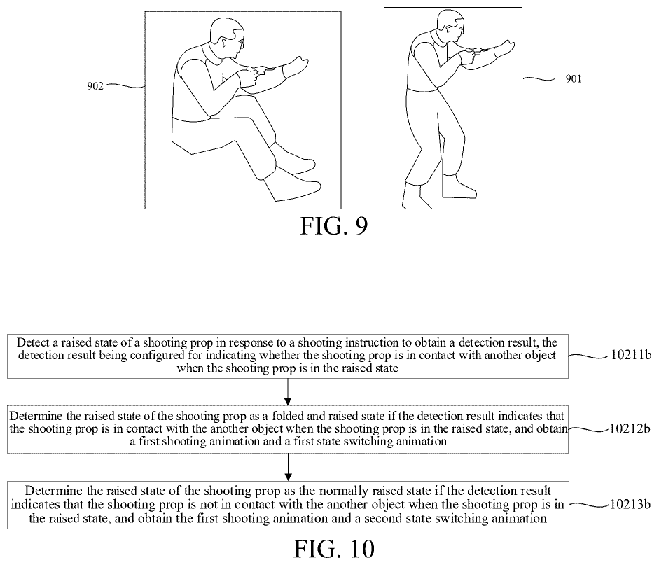

The first pose animation is configured for indicating a basic pose, that is, a pose in which the virtual object outside the virtual vehicle lifts the shooting prop. The second pose animation is similarly configured for indicating a basic pose, that is, a pose in which the virtual object inside the virtual vehicle lifts the shooting prop. The virtual object in the first pose animation and the virtual object in the second pose animation have the same upper body poses but different lower body poses. For example, the lower body of the virtual object in the first pose animation is in a standing state, and the lower body of the virtual object in the second pose animation is in a sitting pose. For example, FIG. 9 is a schematic diagram of a first pose animation and a second pose animation according to an embodiment of the present disclosure. Based on FIG. 9, 901 indicates the first pose animation, and 902 indicates the second pose animation.

Operation 10212a: Superpose the first pose animation, the second shooting animation, and the second pose animation to obtain a first shooting animation.

During actual implementations, a process of superimposing the first pose animation, the second shooting animation, and the second pose animation to obtain the first shooting animation may be: making a difference between a pose parameter of the virtual object in the second shooting animation and a pose parameter of the virtual object in the first pose animation to obtain a superimposition animation resource; and then, superimposing the superimposition animation resource onto the virtual object in the second pose animation to obtain the first shooting animation.

The first shooting animation includes a plurality of first shooting image frames, and the second shooting animation includes a plurality of second shooting image frames. Therefore, the process of superimposing the first pose animation, the second shooting animation, and the second pose animation to obtain the first shooting animation may be performed image frame by image frame. The process of superimposing the first pose animation, the second shooting animation, and the second pose animation to obtain the first shooting animation may be: performing the following processing on each second shooting image frame included in the second shooting animation to obtain the plurality of first shooting image frames: obtaining a value of a pose parameter of the virtual object in the second shooting image frame and a value of a pose parameter of the virtual object in the first pose animation; making a difference between the value of the pose parameter of the virtual object in the second shooting image frame and the value of the pose parameter of the virtual object in the first pose animation to obtain a pose difference; obtaining a value of a pose parameter of the virtual object in the second pose animation, and summing the pose difference with the value of the pose parameter of the virtual object in the second pose animation to obtain the first shooting image frame; and combining the plurality of first shooting image frames to obtain the first shooting animation.

In the foregoing process, the process of making a difference between the pose parameter of the virtual object in the second shooting animation and the pose parameter of the virtual object in the first pose animation to obtain the superimposition animation resource includes: performing the following processing on each second shooting image frame included in the second shooting animation: obtaining the value of the pose parameter of the virtual object in the second shooting image frame and the value of the pose parameter of the virtual object in the first pose animation; making the difference between the value of the pose parameter of the virtual object in the second shooting image frame and the value of the pose parameter of the virtual object in the first pose animation to obtain the pose difference; and determining a plurality of pose differences as the superimposition animation resource. The process of superimposing the superimposition animation resource onto the virtual object in the second pose animation to obtain the first shooting animation includes: obtaining the value of the pose parameter of the virtual object in the second pose animation, and summing the pose difference with the value of the pose parameter of the virtual object in the second pose animation to obtain the first shooting image frame; and combining the plurality of first shooting image frames to obtain the first shooting animation.

The pose parameter in the foregoing process may be configured for indicating each part of a body of a corresponding virtual object, and the value of the pose parameter may be configured for indicating a motion amplitude of the corresponding part.

By applying the foregoing embodiment, in combination with the pose for equipping the shooting prop in the raised state when the virtual object is located outside the virtual vehicle, the process of performing the shooting operation by using the shooting prop in the raised state when the virtual object is located outside the virtual vehicle, and the process of determining to perform the shooting operation by using the shooting prop in the raised state when the virtual object is located in the virtual vehicle by superposing the pose for equipping the shooting prop in the raised state when the virtual object is located inside the virtual vehicle, compared with a solution in the related art in which shooting animation resources that the virtual object is located on the virtual vehicle need to be additionally produced, a lot of resources are saved, and resource consumption and performance overhead are reduced.

During actual implementations, as described above, the raised state includes one of the folded and raised state and the normally raised state, and a distance between the shooting prop in the folded and raised state and the virtual object is less than a distance between the shooting prop in the normally raised state and the virtual object. The state switching animation includes a first state switching animation and a second state switching animation. The first state switching animation is configured for indicating a process of switching the state of the shooting prop from the stowed state to the folded and raised state when the virtual object is located inside the virtual vehicle, and the second state switching animation is configured for indicating a process of switching the shooting prop from the stowed state to the normally raised state when the virtual object is located inside the virtual vehicle. Based on this, for a process of obtaining a state switching animation, referring to FIG. 10, which is a schematic flowchart of a process of obtaining a state switching animation according to an embodiment of the present disclosure. Based on FIG. 10, the process of obtaining the state switching animation according to an embodiment of the present disclosure may be implemented by the following operations.

Operation 10211b: Detect a raised state of a shooting prop in response to a shooting instruction to obtain a detection result, the detection result being configured for indicating whether the shooting prop is in contact with another object when the shooting prop is in the raised state.

The another object may be an object that is inside the virtual vehicle and that is closest to the shooting prop. When the shooting prop is in a normally raised state and is in contact with the another object, the another object may be considered as the foregoing obstacle.

During actual implementations, a process of detecting the raised state of the shooting prop to obtain the detection result may be: obtaining a length of the shooting prop, and a distance between the virtual object and the another object, and comparing the length of the shooting prop with the distance; obtaining, if a comparison result indicates that the length of the shooting prop is less than the distance, the detection result configured for indicating that the shooting prop is not in contact with the another object when the shooting prop is in the raised state; and obtaining, if the comparison result represents that the length of the shooting prop is not less than the distance, the detection result configured for indicating that the shooting prop is in contact with the another object when the shooting prop is in the raised state.

Whether the shooting prop is in contact with the another object when the shooting prop is in the raised state indicates whether the shooting prop is in contact with the another object when the shooting prop is in the normally raised state.

Operation 10212b: Determine the raised state of the shooting prop as a folded and raised state if the detection result indicates that the shooting prop is in contact with the another object when the shooting prop is in the raised state, and obtain a first shooting animation and a first state switching animation.

When the detection result indicates that the shooting prop is in contact with the another object when the shooting prop is in the raised state, the raised state of the shooting prop is determined as the folded and raised state, as described above, that is, the shooting prop is retracted back in a direction of the virtual object, thereby avoiding a phenomenon of clipping caused by the shooting prop and the another object.

During actual implementations, as described above, the folded and raised state includes a backward folded state and a rotated and folded state, and a distance between the shooting prop in the backward folded and raised state and the virtual object is less than a distance between the shooting prop in the normally raised state and the virtual object; a distance between the shooting prop in the rotated, folded, and raised state and the virtual object is less than a distance between the shooting prop in the normally raised state and the virtual object, and is rotated compared with the shooting prop in the normally raised state; and the first state switching animation includes a third state switching animation and a fourth state switching animation, the third state switching animation is configured for indicating a process of switching the state of the shooting prop from the stowed state to a backward folded state when the virtual object is located inside the virtual vehicle, and the fourth state switching animation is configured for indicating a process of switching the state of the shooting prop from the stowed state to a rotated and folded state when the virtual object is located inside the virtual vehicle.

Therefore, a process of obtaining the first shooting animation and the first state switching animation may be: obtaining a contact point between the shooting prop and the another object, and obtaining a distance between the contact point and a virtual camera corresponding to the virtual scene; determining the folded and raised state of the shooting prop as the backward folded state if the distance is not greater than a distance threshold, and obtaining the first shooting animation and the third state switching animation; and determining the folded and raised state of the shooting prop as the rotated and folded state if the distance is greater than the distance threshold, and obtaining the first shooting animation and the fourth state switching animation.

The contact point between the shooting prop and the another object is configured for indicating a contact point and a clipping position between the shooting prop and the another object when the virtual object is not controlled to place the shooting prop in the folded and raised state. If the distance does not exceed the distance threshold, the shooting prop only needs to be displaced backward by a first target distance, that is, the folded and raised state of the shooting prop is determined as the backward folded state, to obtain the third state switching animation, thereby controlling the virtual object to place the shooting prop in the backward folded state. If the distance exceeds the distance threshold, the shooting prop needs to be rotated according to a preset angle, simultaneously the shooting prop is displaced backward by a second target distance to determine the folded and raised state of the shooting prop as the rotated and folded state, and obtain the fourth state switching animation, thereby controlling the virtual object to place the shooting prop in the rotated and folded state, that is, avoiding clipping by rotating, where the second target distance is less than the first target distance.

Operation 10213b: Determine the raised state of the shooting prop as the normally raised state if the detection result indicates that the shooting prop is not in contact with the another object when the shooting prop is in the raised state, and obtain the first shooting animation and a second state switching animation.

By applying the foregoing embodiment, whether the shooting prop is in the normally raised state or the folded and raised state, and whether the shooting prop is in the backward folded state or the rotated and folded state when the shooting prop is in the folded and raised state are determined based on the length of the shooting prop and the distance between the virtual object and another object, thereby determining which state switching animation needs to be obtained. In this way, a process of determining the shooting prop is quantified by comparing the length of the shooting prop with the distance between the virtual object and the another object, thereby improving accuracy of the determined state of the shooting prop, and improving smoothness of a finally obtained target shooting animation.

Operation 1022: Fuse the first shooting animation and the state switching animation to obtain a target shooting animation,
the target shooting animation being configured for indicating an animation process of shooting toward outside of the virtual vehicle by using the shooting prop in the process of switching the state of the shooting prop from the stowed state to the raised state when the virtual object is located inside the virtual vehicle.

During actual implementations, the first shooting animation includes a plurality of first shooting image frames, the state switching animation includes a plurality of state switching image frames, and a quantity of the first shooting image frames included in the first shooting animation is the same as that of the state switching image frames included in the state switching animation. Therefore, the process of fusing the first shooting animation and the state switching animation to obtain the target shooting animation may be: performing the following processing on each first shooting image frame included in the first shooting animation to obtain a plurality of fusion image frames: obtaining a timestamp of the first shooting image frame, and obtaining the state switching image frame with the same timestamp from the state switching animation based on the timestamp; obtaining a first weight of the first shooting image frame and a second weight of the state switching image frame, and fusing the first shooting image frame and the state switching image frame based on the first weight and the second weight to obtain a fusion image frame; and combining the plurality of fusion image frames to obtain the target shooting animation.

The first shooting image frames are processed frame by frame according to a timestamp sequence from an initial timestamp. A sum of the first weight and the second weight is 1. First weights corresponding to different first shooting image frames may be the same or different, and second weights corresponding to different state switching image frames may alternatively be the same or different. That is, in the fusion process, the first weight and the second weight are variable.

For example, for a pose of the virtual object in the first shooting image frame corresponding to the initial timestamp is to shoot by using the shooting prop in the raised state, while the virtual object in the state switching image frame corresponding to a corresponding timestamp is in a state of just picking up the shooting prop in the stowed state in this case, a corresponding fusion image frame mainly displays content of the state switching image frame, the second weight may be set to 0.9, and the first weight may be 0.1.

For a pose of the virtual object in the first shooting image frame corresponding to an intermediate timestamp is to shoot by using the shooting prop in the raised state, while the virtual object in the state switching image frame corresponding to a corresponding timestamp places the shooting prop in a state between the stowed state and the raised state, in this case, a corresponding fusion image frame needs to display both content of the state switching image frame and content of the first shooting image frame, the second weight may be set to 0.5, and the first weight may be 0.5.

For a pose of the virtual object in the first shooting image frame corresponding to an end timestamp is to shoot by using the shooting prop in the raised state, while the virtual object in the state switching image frame corresponding to a corresponding timestamp is in a state of just picking up the shooting prop in the raised state, in this case, the corresponding fusion image frame mainly displays content of the first shooting image frame, the second weight may be set to 0.1, and the first weight may be 0.9.

In this way, by using the first weight and the second weight, a fusion effect of the image frames is smoother and better meets a requirement of an actual scene.

During actual implementations, after the first shooting image frame corresponding to the last timestamp is obtained, and the corresponding fusion image frame is determined, the plurality of fusion image frames are combined to obtain the target shooting animation.

Operation 1023: Play the target shooting animation to display a process in which a virtual object shoots toward outside of a virtual vehicle.

In some other embodiments, the virtual object is equipped with a shooting prop, and the shooting prop is in a raised state. Therefore, a process of controlling, in response to the shooting instruction, the virtual object to shoot toward outside of the virtual vehicle may be: obtaining, in response to the shooting instruction, a first shooting animation to play the first shooting animation, to display a process in which the virtual object shoots toward outside of the virtual vehicle. The process of obtaining the first shooting animation is described above. Details are not described in the embodiments of the present disclosure.

In this way, a shooting animation process of the virtual object located inside the virtual vehicle is determined based on a shooting animation process of the virtual object located outside the virtual vehicle. Compared with a solution in the related art in which shooting animation resources that the virtual object is located on the virtual vehicle need to be additionally produced, a lot of resources are saved, and resource consumption and performance overhead are reduced.

In some embodiments, as described above, the process of controlling the virtual object to aim at the outside of the virtual vehicle and the process of configuring the component of the shooting prop may alternatively be in the process of switching the state of the shooting prop from the stowed state to the raised state. Therefore, the process of controlling, in response to an aiming instruction for the outside of the virtual vehicle, the virtual object to aim at the outside of the virtual vehicle may alternatively be: obtaining the first aiming animation and the state switching animation in response to the aiming instruction for the outside of the virtual vehicle, the first aiming animation being configured for indicating a process of performing an aiming operation on the outside of the virtual vehicle by using the shooting prop in the raised state when the virtual object is located inside the virtual vehicle, and the state switching animation being configured for indicating a process in which the virtual object switches the state of the shooting prop from the stowed state to the raised state inside the virtual vehicle; fusing the first aiming animation and the state switching animation to obtain a target aiming animation, the target aiming animation being configured for indicating a process of performing an aiming operation on the outside of the virtual vehicle by using the shooting prop in the raised state in the process of switching the state of the shooting prop from the stowed state to the raised state when the virtual object is located inside the virtual vehicle; and playing the target aiming animation to display the process in which the virtual object aims outside the virtual vehicle by using the shooting prop in the raised state.

Correspondingly, the process of controlling, in response to a component configuration operation for the shooting prop, the virtual object to configure the key component of the shooting prop may alternatively be: obtaining a first configuration animation and a state switching animation in response to the component configuration operation for the shooting prop, the first shooting animation being configured for indicating a process of performing a shooting operation by using the shooting prop in the raised state when the virtual object is located inside the virtual vehicle, and the state switching animation being configured for indicating a process in which the virtual object switches the state of the shooting prop from the stowed state to the raised state in the virtual vehicle; fusing the first configuration animation and the state switching animation to obtain a target configuration animation, the target configuration animation being configured for indicating a process of performing a configuration operation on the shooting prop in the raised state in a process of switching the state of the shooting prop from the stowed state to the raised state when the virtual object is located inside the virtual vehicle; and playing the target configuration animation to display a process of configuring the shooting prop in the raised state.

The process of obtaining the first aiming animation and the state switching animation and the process of obtaining the first configuration animation and the state switching animation are similar to the foregoing process of obtaining the first shooting animation and the state switching animation. The process of fusing the first aiming animation and the state switching animation to obtain the target aiming animation and the process of fusing the first configuration animation and the state switching animation to obtain the target configuration animation are similar to the foregoing process of fusing the first shooting animation and the state switching animation to obtain the target shooting animation. Details are not described in the embodiments of the present disclosure again.

In some embodiments, the virtual vehicle includes at least one transparent component, the at least one transparent component includes a target transparent component, and the target transparent component is capable of blocking a projection operation that is for the virtual object and that is from an outside of the virtual vehicle. Therefore, before the controlling, in response to the shooting instruction, the virtual object to shoot toward outside of the virtual vehicle, the virtual object may further be controlled, in response to the aiming instruction for the outside of the virtual vehicle, to aim at the outside of the virtual vehicle by using the target transparent component as an observation window. Therefore, the process of controlling, in response to the shooting instruction, the virtual object to shoot toward outside of the virtual vehicle may be: controlling, in response to the shooting instruction when the virtual object completes aiming, the virtual object to shoot toward outside of the virtual vehicle.

The projection operation includes a throwing operation and a shooting operation, and the transparent component on the virtual vehicle may be glass on the virtual vehicle. For example, when the virtual vehicle is a virtual car, the transparent component may be a car window, a front or rear windscreen and a roof window of a virtual car, or the like; and when the virtual vehicle is a virtual aircraft, the transparent component may be an aircraft window or the like. The target transparent component, as a cover of the virtual object, is configured to indicate that the transparent component hinders an attack operation on the virtual object, for example, directly blocking the attack operation on the virtual object, or reducing damage caused by the attack operation on the virtual object. The target transparent component may be preset.

When the virtual object performs an aiming operation, the shooting prop may be in a normally raised state, or may be in a folded and raised state. This is not limited in this embodiment of the present disclosure. The aiming operation may be triggered by using the aiming control, that is, the aiming operation may be a trigger operation for the aiming control, or the aiming operation may be triggered by using at least one of a keyboard, a mouse, or a joystick. This is not limited in this embodiment of the present disclosure.

By applying the foregoing embodiment, the target transparent component blocks the projection operation of the virtual object outside the virtual vehicle, thereby not only increasing diversity of interaction manners in a virtual scene, but also improving human-computer interaction efficiency and utilization of display resources.

During actual implementations, the transparent component may be hidden, and a hidden control for each transparent component is displayed, the hidden control being configured to cancel displaying of a corresponding transparent control that is currently displayed. Therefore, the process of controlling, in response to the shooting instruction when the virtual object completes aiming, the virtual object to shoot toward outside of the virtual vehicle may be: canceling, in response to a trigger operation for a target hidden control of the at least one hidden control when the virtual object completes aiming, the displaying of the corresponding target transparent component; and controlling, in response to the shooting instruction, the virtual object to shoot toward outside of the virtual vehicle by using an area in which the target transparent component whose displaying is canceled is located as the observation window.

Each transparent component has a corresponding hidden control. When a trigger operation for the target hidden control in the at least one hidden control is received, the displaying of the corresponding target transparent component is canceled. The process of canceling the displaying of the corresponding target transparent component herein may be: gradually lowering the target transparent component such as lowering a vehicle window, or may be directly hiding the target transparent component. This is not limited in this embodiment of the present disclosure. Therefore, there is no object in the area in which the target transparent component is located, thereby controlling, in response to the shooting instruction, the virtual object to shoot toward outside of the virtual vehicle by using the area in which the target transparent component whose displaying is canceled is located as the observation window.

During actual implementations, after the displaying of the corresponding target transparent component is canceled, the corresponding target transparent component may further be redisplayed. In some embodiments, the target transparent component is displayed again in response to a trigger operation for the target hidden control. Herein, the target hidden control has two functions. When the target transparent component is displayed, the target hidden control is configured to cancel the displaying of the corresponding target transparent component. When the displaying of the target transparent component is canceled, the target hidden control is configured to display the corresponding target transparent component whose displaying is canceled.

In some other embodiments, a target display control for the target transparent component is displayed, and the target display control is configured to display the target transparent component whose displaying is canceled. The target transparent component is displayed in response to a trigger operation for the target display control. Herein, in addition to a corresponding hidden control, each transparent component further has a corresponding display control. The hidden control is configured to cancel the displaying of the corresponding transparent component that is currently displayed, and the display control is configured to display the corresponding transparent component whose displaying is currently canceled.

In addition to canceling the displaying of the target transparent component by using the hidden control, the virtual object may further be controlled to shatter the target transparent component, thereby canceling the displaying of the target transparent component.

In some particular scenes, it may be set that the virtual object cannot use the shooting prop in the folded and raised state to perform an aiming operation in combination with a scope, or the shooting prop is excessively long, whereby the virtual object cannot perform an aiming operation by using the shooting prop in the folded and raised state. Therefore, in a corresponding scene, the player may perform a trigger operation for the hidden control corresponding to the target transparent component to cancel the displaying of the corresponding target transparent component, or may control the virtual object to perform a shooting operation for the target transparent component, whereby the target transparent component is completely broken and is no longer displayed. Then, when the target transparent component is no longer displayed, the virtual object is controlled to switch the state of the shooting prop from the folded and raised state to the normally raised state, and the virtual object is controlled to aim at the outside of the virtual vehicle based on the shooting prop in the normally raised state, or the virtual object is controlled to aim at the outside of the virtual vehicle by using the shooting prop in the normally raised state in combination with a scope. In this way, behaviors of a player are no longer limited. Although a protection capability of the target transparent component is lost, the virtual object may be controlled to aim freely, thereby improving accuracy of a shooting operation, and generating a gameplay choice that combines both risks and rewards.

In this way, after canceling the displaying of the target transparent component, the player may perform operations of aiming and shooting, after the player completes the operations of aiming and shooting, the target transparent component is displayed, and the player re-obtains a protection capability of the target transparent component, thereby increasing diversity of interaction manners in an interaction process based on reducing a risk of the player being hit.

By applying the foregoing embodiment of the present disclosure, when the virtual object is located in the virtual vehicle, the virtual object may be directly controlled, in response to the shooting instruction, to shoot toward outside of the virtual vehicle. In addition, in a shooting process of the virtual object, the virtual object is wholly located inside the virtual vehicle. In this way, compared with a solution in a related art in which a virtual object in a virtual vehicle has to first lean out and then implement a shooting operation outside the virtual vehicle, an operation of controlling the virtual object to lean out is reduced, and an operation procedure of a shooting process in a virtual scene is simplified, thereby not only improving efficiency of performing the shooting operation in a shooting scene, but also improving human-computer interaction efficiency and utilization of hardware resources of an electronic device.

An exemplary application of this embodiment of the present disclosure in an actual application scene will be described below.

In a game in the related art, when controlling a virtual object to sit in a virtual vehicle, if a player wants to shoot out of the virtual vehicle, the player needs to first control the virtual object to lean out of the virtual vehicle based on a control, then control the virtual object to lean out from the virtual vehicle to shoot toward outside of the virtual vehicle, or first lift a shooting prop, and then to shoot. However, in this way, there are problems such as difficulty in reusing resources and clipping between a shooting prop and a car body. Especially for a game having a complex action system, multiple animation resources need to be produced to support a same operation on a car, and implementation costs are very high. Consequently, shooting efficiency and human-computer interaction efficiency in a virtual scene are relatively low.

Based on this, the embodiments of the present disclosure provide a solution that can shoot and perform a general character operation inside a vehicle. By using mechanisms such as stowing a shooting prop and folding and lifting the shooting prop, a problem of clipping between the shooting prop and a car body is avoided. Moreover, most animations during normal combat can be reused on a car by programmatic processing when the shooting prop is raised, and resources do not need to be additionally produced, thereby saving art manpower, a package size, and memory during running. Moreover, a vehicle does not need to be additionally processed when a new function is subsequently added. In this way, a character can perform operations the same as those on the ground by only sitting in a vehicle without leaning out, and resources do not need to be repeatedly produced.

Next, the technical solution of the present disclosure is described from a product side.

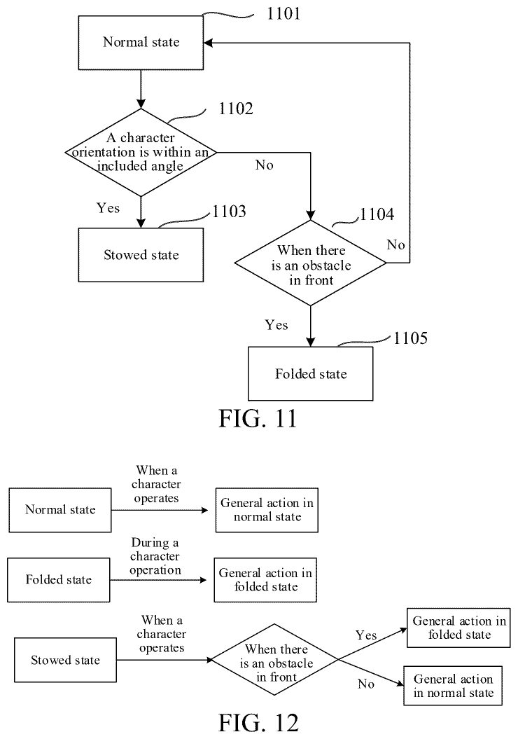

In the technical solution of the present disclosure, the shooting prop may be in a normal state (a normally raised state), a stowed state, and a folded state (a folded and raised state). FIG. 11 is a schematic diagram of state switching of a shooting prop according to an embodiment of the present disclosure. Based on FIG. 11, if the shooting prop in the technical solution of the present disclosure is switched from the normal state to the stowed state or the folded state, this may be implemented by operation 1101 to operation 1105. First, a character (a virtual object) controlled by a player is controlled to switch the shooting prop to be in the normal state, and then the character is controlled to switch the state of the shooting prop from the normal state to the raised state when an orientation of the character is within an included angle (a target angle range); and the character is controlled to switch the state of the shooting prop from the normal state to the stowed state. Whether there is an obstacle in front of the character is determined when the orientation of the character is not within the included angle. The character is controlled to switch the state of the shooting prop from the normal state to the folded state when there is an obstacle in front of the character. The character is controlled to continue remaining the shooting prop in the normal state when there is no obstacle in front of the character. In this way, which action state to enter is automatically determined according to “a character orientation” and “whether there is an obstacle in front” without an operation intervention of a player, thereby achieving a quite automated experience. Secondarily, in the present disclosure, the three states can be automatically switched freely to one another, and motion performance is very smooth.

During actual implementation, when a player needs to perform various operations (general operations such as using a prop and reloading). FIG. 12 is a technical architecture diagram of a player performing a general operation according to an embodiment of the present disclosure. Based on FIG. 12, when the player needs to perform a general operation, a current state of a shooting prop is first determined, and then a to-be-played animation is obtained based on the current state; when the shooting prop is in a normal state, if the character needs to perform the general operation, an animation when the character performs a general action when the shooting prop is in the normal state is obtained; when the shooting prop is in a folded state, if the character needs to perform the general operation, an animation when the character performs the general action when the shooting prop is in the folded state is obtained; when the shooting prop is in a stowed state, if the character needs to perform the general operation, whether there is an obstacle in front of the character is first determined, and if there is an obstacle in front of the character, an animation when the character performs the general action when the shooting prop is in the folded state and an animation of switching the state of the shooting prop from the stowed state to the folded state are obtained, and an animation when the character performs the general action in the process of switching the shooting prop from the stowed state to the folded state is obtained; and if there is no obstacle in front of the character, an animation when the character performs the general action based on the shooting prop in the normal state and an animation of switching the state of the shooting prop from the stowed state to the normal state are obtained, and an animation when the character performs the general action in the process of switching the state of the shooting prop from the stowed state to the normal state is determined. Therefore, the obtained animation is played again. In this way, a lot of resources can be saved, existing ground action assets are directly reused, there is no limitation on a state of the player, and the player can use an operation the same as that on the ground inside a vehicle under any condition, without forcibly changing a lens or a character position of the player.

The animation that the shooting prop is in the folded state does not need to be specially produced, but is obtained by rotating or offsetting the shooting prop held by the character in the animation that the shooting prop is in the normal state, that is, the animation that the shooting prop is in the folded state is obtained by updating the animation that the shooting prop is in the normal state.

Next, the technical solution of the present disclosure is described from a technology side.

According to the technical solution of the present disclosure, a first-person combat mode inside a vehicle is implemented. Leaning out for shooting is not required, and general animation resources may be reused to perform the same operation in the vehicle, for example, reloading or checking a shooting prop without additionally producing art resources. There are mainly three parts in terms of implementation:
1. A resource is reused on a vehicle to perform a general operation (a base pose reuses an upper body)
2. Three states, that is, a stowed state, a normal state, and a folded state, and mutual conversion between the three states on the vehicle

First, a process of reusing a resource on a vehicle is described. First, an animation in a non-vehicle state is mainly based on two states, which are respectively an empty-handed state, that is, a shooting prop is stowed, and a shooting prop equipped state, that is, the shooting prop is raised. The two states have respective base poses, that is, a completely standing state. For example, actions such as healing and climbing are superposition animation resources superposed on the base pose with empty hands, and operations related to the shooting prop, such as reloading, checking the shooting prop, and shooting, are superposition animation resources superposed on the base pose equipped with the shooting prop.

Secondly, because a character on a vehicle needs to sit on a seat, the base pose is different from that on the ground. Therefore, if the superposition animation resources such as healing and reloading on the ground need to be reused, the character needs to have the same base pose as that on the ground, which is apparently impossible. However, actions such as healing and reloading actually only use a skeleton of an upper body, while only a lower body needs to fit the vehicle when a character sits on the vehicle. Therefore, a base pose (a second pose animation) on the vehicle is first generated, and the upper body of a base pose (a first pose animation) in the non-vehicle state is copied to the base pose of the vehicle. Using a base pose equipped with a shooting prop as an example, the base pose in the non-vehicle state and the base pose on the vehicle are as shown in FIG. 9. Based on FIG. 9, it can be seen that upper bodies of two animations are completely the same, and the upper bodies and sub-skeletons thereof are completely the same from a skeleton level. Herein, a characteristic of a superimposition animation is to make a difference between two animations. For animation resources such as reloading and healing in the non-vehicle state, the difference from the base pose in the non-vehicle state is only the upper body. Therefore, the foregoing base pose on the vehicle may directly take all superimposition animations in a non-vehicle state, including healing, reloading, checking a shooting prop, and the like.

Then, design and implementation processes of a stowed state, a normally raised state, and a folded and raised state of the shooting prop on the vehicle are described. In terms of results, a finally achieved effect is: an angle range is given, a player forcibly stows a shooting prop on legs within a specified angle range, and automatically lifts the shooting prop outside the angle range. In this case, the player may fire. In addition to the two states, if it is detected that the shooting prop collides with a collider, folding processing is performed.

During actual implementations, actions of stowing the shooting prop and lifting the shooting prop are implemented by using an animation resource. First, an art engineer designs a Takeup animation, which shows a shooting prop lifting process by forward playing from start to end, and shows a process of stowing the shooting prop by reversely playing front end to start. To achieve better connection between obtaining information about whether the shooting prop is completely lift or completely put down and subsequently performing a general operation, a normal animation playback node is not used herein, but an evaluate sequence node is used. The evaluate sequence node samples, by using an input time, a pose output of a frame from a time point corresponding to the animation resource. Therefore, when two behaviors of stowing the shooting prop and lifting the shooting prop of the vehicle are switched, the same animation is essentially used, but sampling is performed at different time points of the animation.

During actual implementations, two variables, which are respectively bShouldPutDown and TakeupTime, are maintained on an upper layer of an entire vehicle animation system. bShouldPutDown indicates whether the shooting prop needs to be stowed currently, a determining condition is that whether a current angle is within a set range, and a value is False if the current angle is not within the set range. TakeupTime is a to-be-sampled time point input by the evaluate sequence. For stowing and lifting the shooting prop, the TakeupTime increases or decreases in each frame according to the bShouldPutDown.

As an example, a process of performing a general operation is described by using a reloading operation as an example. When the shooting prop is stowed on the vehicle, if the reloading operation needs to be performed, the shooting prop needs to be first raised and then the reloading operation is performed. After the reloading operation is performed, whether to stow the shooting prop again is determined according to a current orientation. Therefore, in the present disclosure, there are two core focuses on the process of performing the general operation: first, an operation time of performing the general operation on the vehicle needs to be the same as an operation time of performing the general operation in the non-vehicle state, that is, gameplay of the general operation cannot be affected by actions of lifting the shooting prop and stowing the shooting prop; and second, the entire process needs to be continuous and cannot skip. Therefore, a finally adopted solution is that: when stowing involves reloading of a prop, a reloading action in the non-vehicle state is calculated first and then is blended with the base pose on the vehicle, and the TakeupTime increases gradually; and after the reloading is completed, the TakeupTime is set as a length of a Takeup animation, that is, an end, and then a normal shooting prop stowing procedure is performed. Herein, during reloading, poses in different general operations are different, reloading can only be performed in a blended manner. After reloading is completed, a normal animation of stowing the shooting prop can be played. In this case, a normal switching process from stowing the shooting prop to lifting the shooting prop is returned.

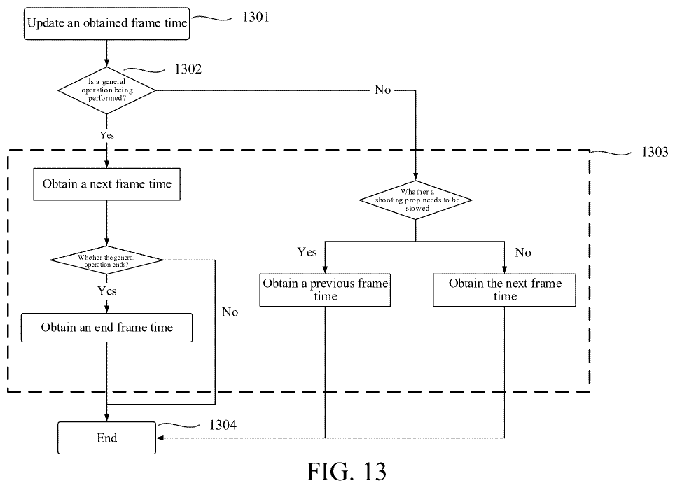

FIG. 13 is a schematic diagram of an update procedure of TakeupTime according to an embodiment of the present disclosure. Based on FIG. 13, a TakeupTime update process according to this embodiment of the present disclosure is implemented by operation 1301 to operation 1304. An obtained frame time is updated, then whether a general operation is being performed currently is determined, if the general operation is being performed, a next frame time is obtained, then whether the general operation ends is determined based on the obtained next frame time, when the general operation ends, a last frame time is obtained, then a normal procedure of stowing a shooting prop is performed, or when the general operation does not end, a processing process of this frame time is ended, and the obtained frame time is updated again. If the general operation is not being performed, whether the shooting prop needs to be stowed is determined. When the shooting prop needs to be stowed, it indicates that the general operation is completed, and a previous frame time is obtained, that is, a Takeup animation is reversely played. When the shooting prop does not need to be stowed, a next frame time is obtained, and then whether the general operation ends is determined based on the obtained next frame time. When the general operation ends, a last frame time is obtained, and then a normal procedure of stowing the shooting prop is performed. When the general operation does not end, a processing process of this frame time is ended, and the obtained frame time is updated again.

The frame time herein is a time of each image frame, the next frame time is obtained by adding a unit frame time to a current frame time, and correspondingly, the previous frame time is obtained by subtracting a unit frame time from a current frame time. In addition, herein, after the frame time is obtained, an image frame corresponding to the frame time in the animation may be determined, thereby processing the image frame, that is, implementing a process of controlling a character to perform a general operation in a process of switching the state of the shooting prop from a stowed state to a raised state based on the image frame.

For a folded state of the shooting prop, the folded state is a function in the non-vehicle state, to prevent the shooting prop and a collider from clipping. Connecting a system for folding the shooting prop to the vehicle can ensure that a clipping phenomenon does not occur during stowing and lifting the shooting prop complicatedly and during a general operation. Folding the shooting prop may be understood as post-processing, that is, after calculations for stowing and lifting the shooting prop and the general operation are completed, whether the shooting prop is set in a folded state is calculated according to a position and orientation of the shooting prop in this case, which is equivalent to additionally performing some offset or rotation after animation calculation. Specifically, a ray is drawn from a root point of the shooting prop, that is, a position of a character, to the orientation of the shooting prop. A length of the ray is a length of a collider of the shooting prop. If there is a contact point, it indicates that the shooting prop needs to be folded and raised. According to a distance between the contact point and a virtual camera, if the distance does not exceed a particular range, the shooting prop only needs to be displaced backward by a corresponding distance (a backward folded state). If the distance exceeds a particular range, the shooting prop needs to be rotated according to a preset value, and moreover, in this case, only a set relatively small backward displacement (a rotated and folded state) is needed, that is, clipping is mainly avoided by rotating.

In this way, in this solution, first-person perspective shooting and another general operation inside a vehicle may be implemented on a mobile platform, smoothness of a state switching process of a shooting prop is improved, and resources in the non-vehicle state are basically reused. Compared with the related art in which an animation resource needs to be additionally generated for a vehicle on the vehicle, the present disclosure saves a lot of resources, and has lower performance overhead.

By applying the foregoing embodiment of the present disclosure, when the virtual object is located in the virtual vehicle, the virtual object may be directly controlled, in response to the shooting instruction, to shoot toward outside of the virtual vehicle. In addition, in a shooting process of the virtual object, the virtual object is wholly located inside the virtual vehicle. In this way, compared with a solution in a related art in which a virtual object in a virtual vehicle has to first lean out and then implement a shooting operation outside the virtual vehicle, an operation of controlling the virtual object to lean out is reduced, and an operation procedure of a shooting process in a virtual scene is simplified, thereby not only improving efficiency of performing the shooting operation in a shooting scene, but also improving human-computer interaction efficiency and utilization of hardware resource of an electronic device.

The following continues to describe an exemplary structure of an apparatus 455 for shooting in a virtual scene according to an embodiment of the present disclosure implemented as software modules. In some embodiments, as shown in FIG. 2, the software modules of the apparatus 455 for shooting in the virtual scene stored in a memory 450 may include:
a display module 4551, configured to display, in a virtual scene, a virtual vehicle and a virtual object located in the virtual vehicle; and
a control module 4552, configured to control, in response to a shooting instruction, the virtual object to shoot toward outside of the virtual vehicle, in a process in which the virtual object shoots toward outside of the virtual vehicle, the virtual object being wholly located inside the virtual vehicle.

In some embodiments, the apparatus further includes a second control module. The second control module is configured to: control, when there is an obstacle directly in front of the virtual object, the virtual object to place a shooting prop in a folded and raised state, a distance between the shooting prop in the folded and raised state and the virtual object being less than a distance between the shooting prop in a normally raised state and the virtual object. The control module 4552 is further configured to control, in response to the shooting instruction, the virtual object to shoot toward outside of the virtual vehicle by using the shooting prop in the folded and raised state.

In some embodiments, the virtual object is equipped with a shooting prop, and the apparatus further includes a third control module. The third control module is configured to control, when an orientation of the virtual object is within a target angle range, the virtual object to place the shooting prop in a stowed state. The control module 4552 is further configured to: control, in response to the shooting instruction, the virtual object to gradually switch a state of the shooting prop from the stowed state to a raised state; and control, in a process of switching the state of the shooting prop from the stowed state to the raised state, the virtual object to shoot toward outside of the virtual vehicle by using the shooting prop.

In some embodiments, the apparatus further includes a fourth control module. The fourth control module is configured to control, when the virtual object completes shooting toward outside of the virtual vehicle, the virtual object to switch the state of the shooting prop from the raised state to the stowed state.

In some embodiments, the virtual object performs shooting toward outside of the virtual vehicle based on the shooting prop. The apparatus for includes a configuration module. The configuration module is configured to control, in response to a component configuration operation for the shooting prop, the virtual object to configure a key component of the shooting prop, the key component of the shooting prop including at least one of the following: a scope, a virtual sub-prop corresponding to the shooting prop, a muffler, and a virtual stock.

In some embodiments, the configuration module is further configured to: control, in response to the configuration operation for the shooting prop when the shooting prop of the virtual object is in the stowed state, the virtual object to gradually switch the state of the shooting prop from the stowed state to the raised stated; and control the virtual object to configure the component of the shooting prop in the process of switching the state of the shooting prop from the stowed state to the raised state.

In some embodiments, the virtual object performs shooting toward outside of the virtual vehicle based on the shooting prop, and the shooting prop includes at least one key component. The apparatus further includes a detection module. The detection module is configured to: detect a state of each key component of the shooting prop to obtain a detection result, the state including a normal state and a target state for configuration; and display configuration prompt information when the detection result represents that a target key component of the at least one key component is in the target state for configuration, the configuration prompt information being configured for prompting to configure the target key component.

In some embodiments, the virtual object is equipped with a shooting prop, and the shooting prop is in a stowed state. The apparatus further includes a fifth control module. The fifth control module is configured to: control, in response to a perspective conversion instruction for the virtual object, the virtual object to perform perspective conversion; and control, when an orientation of the virtual object on which the perspective conversion has been performed is not within a target angle range, the virtual object to switch the state of the shooting prop from the stowed state to the raised state. The control module 4552 is further configured to control, in response to the shooting instruction, the virtual object to shoot toward outside of the virtual vehicle by using the shooting prop in the raised state.

In some embodiments, the display module 4551 is further configured to: display, in the virtual scene, a virtual vehicle and a virtual object located outside the virtual vehicle, the shooting prop equipped on the virtual object being in the raised state when the virtual object is located outside the virtual vehicle; and control, in response to a vehicle entering instruction for the virtual object, the virtual object to enter the virtual vehicle, and control the virtual object to switch the state of the shooting prop from the raised state to the stowed state.

In some embodiments, the raised state includes a folded and raised state, and a distance between the shooting prop in the folded and raised state and the virtual object is less than a distance between the shooting prop in a normally raised state and the virtual object. The fifth control module is further configured to control, when the orientation of the virtual object on which the perspective conversion has been performed is not within the target angle range, the virtual object to switch the state of the shooting prop from the stowed state to the folded and raised state in response to that there is an obstacle directly in front of the virtual object. The control module 4552 is further configured to control, in response to the shooting instruction, the virtual object to shoot toward outside of the virtual vehicle by using the shooting prop in the folded and raised state.

In some embodiments, the virtual object is equipped with a shooting prop, and the shooting prop is in a stowed state. The control module 4552 is further configured to: obtain a first shooting animation and a state switching animation in response to the shooting instruction, the first shooting animation being configured for indicating a process of performing a shooting operation by using the shooting prop in the raised state when the virtual object is located inside the virtual vehicle, and the state switching animation being configured for indicating a process in which the virtual object switches the state of the shooting prop from the stowed state to the raised state in the virtual vehicle; fuse the first shooting animation and the state switching animation to obtain a target shooting animation, the target shooting animation being configured for indicating an animation process of shooting toward outside of the virtual vehicle by using the shooting prop in the process of switching the state of the shooting prop from the stowed state to the raised state when the virtual object is located inside the virtual vehicle; and play the target shooting animation to display a process in which the virtual object shoots toward outside of the virtual vehicle.

In some embodiments, the first shooting animation includes a plurality of first shooting image frames, the state switching animation includes a plurality of state switching image frames, and a quantity of the first shooting image frames included in the first shooting animation is the same as that of the state switching image frames included in the state switching animation. The control module 4552 is further configured to perform the following processing on each first shooting image frame included in the first shooting animation to obtain a plurality of fusion image frames: obtaining a timestamp of the first shooting image frame, and obtaining the state switching image frame with the same timestamp from the state switching animation based on the timestamp; obtaining a first weight of the first shooting image frame and a second weight of the state switching image frame, and fusing the first shooting image frame and the state switching image frame based on the first weight and the second weight to obtain a fusion image frame; and combining the plurality of fusion image frames to obtain the target shooting animation.

In some embodiments, the control module 4552 is further configured to: obtain a first pose animation of the virtual object, a second shooting animation of the virtual object, and a second pose animation of the virtual object, the first pose animation being configured for indicating a pose for equipping the shooting prop in the raised state when the virtual object is located outside the virtual vehicle, the second shooting animation being configured for indicating a process of performing the shooting operation by using the shooting prop in the raised state when the virtual object is located outside the virtual vehicle, the second pose animation being configured for indicating a pose for equipping the shooting prop in the raised state when the virtual object is located inside the virtual vehicle, and the virtual object in the first pose animation and the virtual object in the second pose animation having the same upper body pose; and superimpose the first pose animation, the second shooting animation, and the second pose animation to obtain the first shooting animation.

In some embodiments, the first shooting animation includes a plurality of first shooting image frames, and the second shooting animation includes a plurality of second shooting image frames. The control module 4552 is further configured to perform the following processing on each second shooting image frame included in the second shooting animation to obtain the plurality of first shooting image frames: obtaining a value of a pose parameter of the virtual object in the second shooting image frame and a value of a pose parameter of the virtual object in the first pose animation; making a difference between the value of the pose parameter of the virtual object in the second shooting image frame and the value of the pose parameter of the virtual object in the first pose animation to obtain a pose difference; obtaining a value of a pose parameter of the virtual object in the second pose animation, and summing the pose difference with the value of the pose parameter of the virtual object in the second pose animation to obtain the first shooting image frame; and combining the plurality of first shooting image frames to obtain the first shooting animation.

In some embodiments, the raised state includes one of a folded and raised state and a normally raised state, and a distance between the shooting prop in the folded and raised state and the virtual object is less than a distance between the shooting prop in the normally raised state and the virtual object. The state switching animation includes a first state switching animation and a second state switching animation. The first state switching animation is configured for indicating a process of switching the state of the shooting prop from the stowed state to the folded and raised state when the virtual object is located inside the virtual vehicle, and the second state switching animation is configured for indicating a process of switching the shooting prop from the stowed state to the normally raised state when the virtual object is located inside the virtual vehicle. The control module 4552 is further configured to: detect a raised state of the shooting prop in response to the shooting instruction to obtain a detection result, the detection result configured for indicating whether the shooting prop is in contact with another object when the shooting prop is in the raised state; determine the raised state of the shooting prop as the folded and raised state if the detection result indicates that the shooting prop is in contact with another object when the shooting prop is in the raised state, and obtain the first shooting animation and the first state switching animation; and determine the raised state of the shooting prop as the normally raised state if the detection result indicates that the shooting prop is not in contact with another object when the shooting prop is in the raised state, and obtain the first shooting animation and the second state switching animation.

In some embodiments, the control module 4552 is further configured to: obtain a length of the shooting prop, and a distance between the virtual object and the another object; compare the length of the shooting prop with the distance; obtain, if a comparison result indicates that the length of the shooting prop is less than the distance, the detection result configured for indicating that the shooting prop is not in contact with the another object when the shooting prop is in the raised state; and obtain, if the comparison result represents that the length of the shooting prop is not less than the distance, the detection result configured for indicating that the shooting prop is in contact with the another object when the shooting prop is in the raised state.

In some embodiments, the folded and raised state includes a backward folded state and a rotated and folded state, and a distance between the shooting prop in the backward folded and raised state and the virtual object is less than a distance between the shooting prop in the normally raised state and the virtual object; a distance between the shooting prop in the rotated, folded, and raised state and the virtual object is less than a distance between the shooting prop in the normally raised state and the virtual object, and is rotated compared with the shooting prop in the normally raised state; and the first state switching animation includes a third state switching animation and a fourth state switching animation, the third state switching animation is configured for indicating a process of switching the state of the shooting prop from the stowed state to a backward folded state when the virtual object is located inside the virtual vehicle, and the fourth state switching animation is configured for indicating a process of switching the state of the shooting prop from the stowed state to a rotated and folded state when the virtual object is located inside the virtual vehicle. The control module 4552 is further configured to: obtain a contact point between the shooting prop and the another object, and obtain a distance between the contact point and a virtual camera corresponding to the virtual scene; determine the folded and raised state of the shooting prop as the backward folded state if the distance is not greater than a distance threshold, and obtain the first shooting animation and the third state switching animation; and determine the folded and raised state of the shooting prop as the rotated and folded state if the distance is greater than the distance threshold, and obtain the first shooting animation and the fourth state switching animation.

In some embodiments, the virtual vehicle includes at least one transparent component, the at least one transparent component includes a target transparent component, and the target transparent component is capable of blocking a projection operation that is for the virtual object and that is from an outside of the virtual vehicle. The apparatus further includes a sixth control module. The sixth control module is configured to control, in response to an aiming instruction for the outside the virtual vehicle, the virtual object to aim at the outside of the virtual vehicle by using the target transparent component as an observation window. The control module 4552 is further configured to control, in response to the shooting instruction when the virtual object completes aiming, the virtual object to shoot toward outside of the virtual vehicle.

In some embodiments, the apparatus further includes a seventh control module. The seventh control module is configured to display a hidden control for each transparent component, the hidden control being configured to cancel displaying of the corresponding transparent control that is currently displayed. The control module 4552 is further configured to: cancel, in response to a trigger operation for a target hidden control of the at least one hidden control when the virtual object completes aiming, the displaying of the corresponding target transparent component; and control, in response to the shooting instruction, the virtual object to shoot toward outside of the virtual vehicle by using an area in which the target transparent component whose displaying is canceled is located as the observation window.

An embodiment of the present disclosure provides a computer program product, including computer-executable instructions or a computer program, the computer-executable instructions or the computer program being stored in a computer-readable storage medium. A processor of an electronic device reads the computer-executable instructions or the computer program from the computer-readable storage medium, and the processor executes the computer-executable instructions or the computer program, whereby the electronic device performs the foregoing method for shooting in a virtual scene in the embodiments of the present disclosure.

An embodiment of the present disclosure provides a computer-readable storage medium, having computer executable instructions or a computer program stored therein, the computer executable instructions, when executed by a processor, causing the processor to perform the method for shooting in a virtual scene according to the embodiments of the present disclosure, for example, the method for shooting in the virtual scene shown in FIG. 3.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM; or may be various devices including one or any combination of the foregoing memories.

In some embodiments, the computer-executable instructions may be in the form of a program, software, a software module, a script, or code, programmed in any form of programming language (including compiled or interpreted languages, or declarative or procedural languages), may be deployed in any form, and includes other units that are deployed as a standalone program or as a module, component, subroutine, or are suitable to be used in a computing environment.

As an example, the computer-executable instructions may be, but not necessarily, corresponding to a file in a file system, may be stored in a part of the file for saving other programs or data, for example, stored in one or more scripts in a hyper text markup language (HTML) file, stored in a single file specifically used for the program being discussed, or stored in a plurality of collaborative files (for example, a file storing one or more modules, a submodule, or a code part).

As an example, the computer-executable instructions may be deployed on a computing device for executing, or executed on a plurality of computing devices located at a location, or executed on a plurality of computing devices distributed in a plurality of locations and interconnected by using communication networks.

In conclusion, the embodiments of the present disclosure have the following beneficial effects.

(1) Compared with a solution in a related art in which a virtual object in a virtual vehicle has to first lean out and then implement a shooting operation outside the virtual vehicle, an operation of controlling the virtual object to lean out is reduced, and an operation procedure of a shooting process in a virtual scene is simplified, thereby not only improving efficiency of performing the shooting operation in a shooting scene, but also improving human-computer interaction efficiency and utilization of hardware resource of an electronic device.

(2) By using the first weight and the second weight, a fusion effect of the image frames is smoother and better meets a requirement of an actual scene.

(3) A shooting animation process of the virtual object located inside the virtual vehicle is determined based on a shooting animation process of the virtual object located outside the virtual vehicle. Compared with a solution in the related art in which shooting animation resources that the virtual object is located on the virtual vehicle need to be additionally produced, a lot of resources are saved, and resource consumption and performance overhead are reduced.

In the embodiments of the present disclosure, obtaining of relevant data such as operation data of a user is involved. When the embodiments of the present disclosure are applied to a specific product or technology, user permission or consent needs to be obtained, and the collection, use, and processing of the relevant data need to comply with relevant laws, regulations, and standards of relevant countries and regions.

As such, the embodiments of the present disclosure have the following beneficial effects. When the virtual object is located in the virtual vehicle, the virtual object may be directly controlled, in response to the shooting instruction, to shoots toward outside of the virtual vehicle. In addition, in a shooting process of the virtual object, the virtual object is wholly located inside the virtual vehicle. In this way, compared with a solution in a related art in which a virtual object in a virtual vehicle has to first lean out and then implement a shooting operation outside the virtual vehicle, an operation of controlling the virtual object to lean out is reduced, and an operation procedure of a shooting process in a virtual scene is simplified, thereby not only improving efficiency of performing the shooting operation in a shooting scene, but also improving human-computer interaction efficiency and utilization of hardware resources of an electronic device.

The foregoing descriptions are merely embodiments of the present disclosure and are not intended to limit the protection scope of the present disclosure. Any modification, equivalent replacement, or improvement made without departing from the spirit and principle of the present disclosure fall within the protection scope of the present disclosure.

What is claimed is:

1. A method for shooting in a virtual scene, performed by an electronic device, and comprising:
displaying, in a virtual scene, a virtual vehicle and a virtual object located in the virtual vehicle; and
controlling, in response to a shooting instruction, the virtual object to shoot toward outside of the virtual vehicle,
during a process that the virtual object shoots toward outside of the virtual vehicle, an entirety of the virtual object being located inside the virtual vehicle.

2. The method according to claim 1, wherein the virtual object is equipped with a shooting prop, and the method further comprises:
controlling, when an obstacle is directly in front of the virtual object, the virtual object to place the shooting prop in a folded and raised state,
a distance between the shooting prop in the folded and raised state and the virtual object being less than a distance between the shooting prop in a normally raised state and the virtual object; and
controlling, in response to the shooting instruction, the virtual object to shoot toward outside of the virtual vehicle comprises:
controlling, in response to the shooting instruction, the virtual object to shoot toward outside of the virtual vehicle by using the shooting prop in the folded and raised state.

3. The method according to claim 1, wherein the virtual object is equipped with a shooting prop, and the method further comprises:
controlling, when an orientation of the virtual object is within a target angle range, the virtual object to place the shooting prop in a stowed state;
controlling, in response to the shooting instruction, the virtual object to shoot toward outside of the virtual vehicle comprises: controlling, in response to the shooting instruction, the virtual object to gradually switch a state of the shooting prop from the stowed state to a raised state; and
controlling, in a process of switching the state of the shooting prop from the stowed state to the raised state, the virtual object to shoot toward outside of the virtual vehicle by using the shooting prop,
wherein the method further comprises:
controlling, when the virtual object completes the shooting toward outside of the virtual vehicle, the virtual object to switch the state of the shooting prop from the raised state to the stowed state.

4. The method according to claim 1, wherein the virtual object performs the shooting toward outside of the virtual vehicle based on the shooting prop, and the method further comprises:
controlling, in response to a component configuration operation for the shooting prop, the virtual object to configure a key component of the shooting prop,
the key component of the shooting prop comprising at least one of following: a scope, a virtual sub-prop corresponding to the shooting prop, a muffler, or a virtual stock.

5. The method according to claim 4, wherein controlling, in response to the component configuration operation for the shooting prop, the virtual object to configure the component of the shooting prop comprises:
controlling, in response to the configuration operation for the shooting prop when the shooting prop equipped on the virtual object is in a stowed state, the virtual object to gradually switch the state of the shooting prop from the stowed state to a raised state; and
controlling, in the process of switching the state of the shooting prop from the stowed state to the raised state, the virtual object to configure the component of the shooting prop.

6. The method according to claim 1, wherein the virtual object performs the shooting toward outside of the virtual vehicle based on the shooting prop, and the shooting prop comprises at least one key component; and
the method further comprises:
detecting a state of each key component of the shooting prop to obtain a detection result, and the state comprising a normal state and a target state for configuration; and
displaying configuration prompt information when the detection result represents that a target key component of the at least one key component is in the target state for configuration, the configuration prompt information being configured for prompting to configure the target key component.

7. The method according to claim 1, wherein the virtual object is equipped with the shooting prop, and the shooting prop is in a stowed state;
the method further comprises:
controlling, in response to a perspective conversion instruction for the virtual object, the virtual object to perform perspective conversion; and
controlling, when an orientation of the virtual object on which the perspective conversion has been performed is not within the target angle range, the virtual object to switch the state of the shooting prop from the stowed state to a raised state; and
controlling, in response to the shooting instruction, the virtual object to shoot toward outside of the virtual vehicle comprises:
controlling, in response to the shooting instruction, the virtual object to shoot toward outside of the virtual vehicle by using the shooting prop in the raised state.

8. The method according to claim 7, wherein displaying, in the virtual scene, the virtual vehicle and the virtual object located in the virtual vehicle comprises:
displaying, in the virtual scene, the virtual vehicle and the virtual object located outside the virtual vehicle, the shooting prop equipped on the virtual object being in the raised state when the virtual object is located outside the virtual vehicle; and
controlling, in response to a vehicle entering instruction for the virtual object, the virtual object to enter the virtual vehicle, and controlling the virtual object to switch the state of the shooting prop from the raised state to the stowed state.

9. The method according to claim 7, wherein the raised state comprises a folded and raised state and a normally raised state, and the distance between the shooting prop in the folded and raised state and the virtual object is less than the distance between the shooting prop in the normally raised state and the virtual object;
controlling, when the orientation of the virtual object on which the perspective conversion has been performed is not within the target angle range, the virtual object to switch the state of the shooting prop from the stowed state to the raised state comprises:
controlling, when the orientation of the virtual object on which the perspective conversion has been performed is not within the target angle range, the virtual object to switch the state of the shooting prop from the stowed state to the folded and raised state in response to that the obstacle is directly in front of the virtual object; and
controlling, in response to the shooting instruction, the virtual object to shoot toward outside of the virtual vehicle by using the shooting prop in the raised state comprises:
controlling, in response to the shooting instruction triggered based on a shooting control, the virtual object to shoot toward outside of the virtual vehicle by using the shooting prop in the folded and raised state.

10. The method according to claim 1, wherein the virtual object is equipped with a shooting prop, and the shooting prop is in a stowed state;
controlling, in response to a shooting instruction, the virtual object to shoot toward outside of the virtual vehicle comprises:
obtaining a first shooting animation and a state switching animation in response to the shooting instruction,
the first shooting animation being configured for indicating a process of performing a shooting operation by using the shooting prop in a raised state when the virtual object is located inside the virtual vehicle, and the state switching animation being configured for indicating a process in which the virtual object switches the state of the shooting prop from the stowed state to the raised state in the virtual vehicle;
fusing the first shooting animation and the state switching animation to obtain a target shooting animation,
the target shooting animation indicating an animation process of shooting toward outside of the virtual vehicle by using the shooting prop in the process of switching the state of the shooting prop from the stowed state to the raised state when the virtual object is located inside the virtual vehicle; and
playing the target shooting animation to display a process in which the virtual object shoots toward outside of the virtual vehicle.

11. The method according to claim 10, wherein the first shooting animation comprises a plurality of first shooting image frames, the state switching animation comprises a plurality of state switching image frames, and a quantity of the first shooting image frames comprised in the first shooting animation is the same as that of the state switching image frames comprised in the state switching animation; and
fusing the first shooting animation and the state switching animation to obtain the target shooting animation comprises:
performing the following processing on each first shooting image frame comprised in the first shooting animation to obtain a plurality of fusion image frames: obtaining a timestamp of the first shooting image frame, and obtaining the state switching image frame with the same timestamp from the state switching animation based on the timestamp; and obtaining a first weight of the first shooting image frame and a second weight of the state switching image frame, and fusing the first shooting image frame and the state switching image frame based on the first weight and the second weight to obtain the fusion image frame; and
combining the plurality of fusion image frames to obtain the target shooting animation.

12. The method according to claim 10, wherein obtaining a first shooting animation comprises:
obtaining a first pose animation of the virtual object, a second shooting animation of the virtual object, and a second pose animation of the virtual object,
the first pose animation being configured for indicating a pose for equipping the shooting prop in the raised state when the virtual object is located outside the virtual vehicle, the second shooting animation being configured for indicating a process of performing the shooting operation by using the shooting prop in the raised state when the virtual object is located outside the virtual vehicle, the second pose animation being configured for indicating a pose for equipping the shooting prop in the raised state when the virtual object is located inside the virtual vehicle, and the virtual object in the first pose animation and the virtual object in the second pose animation having the same upper body pose; and
superimposing the first pose animation, the second shooting animation, and the second pose animation to obtain the first shooting animation.

13. The method according to claim 12, wherein the first shooting animation comprises a plurality of first shooting image frames, and the second shooting animation comprises a plurality of second shooting image frames; and
superimposing the first pose animation, the second shooting animation, and the second pose animation to obtain the first shooting animation comprises:
performing the following processing on each second shooting image frame comprised in the second shooting animation to obtain the plurality of first shooting image frames: obtaining a value of a pose parameter of the virtual object in the second shooting image frame and a value of a pose parameter of the virtual object in the first pose animation; making a difference between the value of the pose parameter of the virtual object in the second shooting image frame and the value of the pose parameter of the virtual object in the first pose animation to obtain a pose difference; and obtaining a value of a pose parameter of the virtual object in the second pose animation, and summing the pose difference with the value of the pose parameter of the virtual object in the second pose animation to obtain the first shooting image frame; and
combining the plurality of first shooting image frames to obtain the first shooting animation.

14. The method according to claim 10, wherein the raised state comprises one of the folded and raised state and the normally raised state, and the distance between the shooting prop in the folded and raised state and the virtual object is less than the distance between the shooting prop in the normally raised state and the virtual object;
the state switching animation comprises a first state switching animation and a second state switching animation, the first state switching animation is configured for indicating a process of switching the state of the shooting prop from the stowed state to the folded and raised state when the virtual object is located inside the virtual vehicle, and the second state switching animation is configured for indicating a process of switching the shooting prop from the stowed state to the normally raised state when the virtual object is located inside the virtual vehicle; and
obtaining the first shooting animation and the state switching animation in response to the shooting instruction comprises:
detecting the raised state of the shooting prop in response to the shooting instruction to obtain a detection result, the detection result being configured for indicating whether the shooting prop is in contact with another object when the shooting prop is in the raised state;
determining the raised state of the shooting prop as the folded and raised state when the detection result indicates that the shooting prop is in contact with another object when the shooting prop is in the raised state, and obtaining the first shooting animation and the first state switching animation; and
determining the raised state of the shooting prop as the normally raised state when the detection result indicates that the shooting prop is not in contact with another object when the shooting prop is in the raised state, and obtaining the first shooting animation and the second state switching animation.

15. The method according to claim 14, wherein detecting the raised state of the shooting prop to obtain the detection result comprises:
obtaining a length of the shooting prop, and a distance between the virtual object and the another object;
comparing the length of the shooting prop with the distance;
obtaining, when a comparison result indicates that the length of the shooting prop is less than the distance, the detection result for indicating that the shooting prop is not in contact with another object when the shooting prop is in the raised state; and
obtaining, when a comparison result indicates that the length of the shooting prop is not less than the distance, the detection result for indicating that the shooting prop is in contact with the another object when the shooting prop is in the raised state.

16. The method according to claim 14, wherein the folded and raised state comprises a backward folded state and a rotated and folded state, and a distance between the shooting prop in the backward folded and raised state and the virtual object is less than a distance between the shooting prop in the normally raised state and the virtual object; and a distance between the shooting prop in a rotated, folded, and raised state and the virtual object is less than a distance between the shooting prop in the normally raised state and the virtual object, and is rotated compared with the shooting prop in the normally raised state;
the first state switching animation comprises a third state switching animation and a fourth state switching animation, the third state switching animation is configured for indicating a process of switching the state of the shooting prop from the stowed state to the backward folded state when the virtual object is located inside the virtual vehicle, and the fourth state switching animation is configured for indicating a process of switching the state of the shooting prop from the stowed state to the rotated and folded state when the virtual object is located inside the virtual vehicle; and
obtaining the first shooting animation and the first state switching animation comprises:
obtaining a contact point between the shooting prop and the another object, and obtaining a distance between the contact point and a virtual camera corresponding to the virtual scene;
determining the folded and raised state of the shooting prop as the backward folded state if the distance is not greater than a distance threshold, and obtaining the first shooting animation and the third state switching animation; and
determining the folded and raised state of the shooting prop as the rotated and folded state if the distance is greater than the distance threshold, and obtaining the first shooting animation and the fourth state switching animation.

17. The method according to claim 1, wherein the virtual vehicle comprises at least one transparent component, the at least one transparent component comprises a target transparent component, and the target transparent component is capable of blocking a projection operation that is for the virtual object and that is from an outside of the virtual vehicle; the method further comprises:
controlling, in response to an aiming instruction for the outside of the virtual vehicle, the virtual object to aim at the outside of the virtual vehicle by using the target transparent component as an observation window; and
controlling, in response to the shooting instruction, the virtual object to shoot toward outside of the virtual vehicle comprises:
controlling, in response to the shooting instruction when the virtual object completes aiming, the virtual object to shoot toward outside of the virtual vehicle.

18. The method according to claim 17, further comprising:
displaying a hidden control for each transparent component, the hidden control being configured to cancel displaying of a corresponding transparent control that is currently displayed; and
controlling, in response to the shooting instruction when the virtual object completes the aiming, the virtual object to shoot toward outside of the virtual vehicle comprises:
canceling, in response to a trigger operation for a target hidden control of the at least one hidden control when the virtual object completes the aiming, the displaying of the corresponding target transparent component; and
controlling, in response to the shooting instruction, the virtual object to shoot toward outside of the virtual vehicle by using an area in which the target transparent component whose displaying is canceled is located as the observation window.

19. An electronic device, comprising:
one or more processors and a memory containing computer-executable instructions or a computer program that, when being executed, cause the one or more processors to perform:
displaying, in a virtual scene, a virtual vehicle and a virtual object located in the virtual vehicle; and
controlling, in response to a shooting instruction, the virtual object to shoot toward outside of the virtual vehicle,
during a process that the virtual object shoots toward outside of the virtual vehicle, an entirety of the virtual object being located inside the virtual vehicle.

20. A non-transitory computer-readable storage medium containing computer-executable instructions or a computer program that, when being executed, cause at least one processor to perform:
displaying, in a virtual scene, a virtual vehicle and a virtual object located in the virtual vehicle; and
controlling, in response to a shooting instruction, the virtual object to shoot toward outside of the virtual vehicle,
during a process that the virtual object shoots toward outside of the virtual vehicle, an entirety of the virtual object being located inside the virtual vehicle.
